(19) United States
(12) Patent Application Publication
(10) Pub. No.: US 2016/0013661 A1
(43) Pub. Date: Jan. 14, 2016

(54) RESONATORS FOR WIRELESS POWER TRANSFER SYSTEMS

(71) Applicant: WiTricity Corporation, Watertown, MA (US)

(72) Inventors: Andre B. Kurs, Chestnut Hill, MA (US); Guillaume Lestoquoy, Cambridge, MA (US); Morris P. Kesler, Bedford, MA (US)

(21) Appl. No.: 14/794,062

(22) Filed: Jul. 8, 2015

Related U.S. Application Data
(60) Provisional application No. 62/021,925, filed on Jul. 8, 2014.

(51) Int. Cl. H02J 5/00; H02J 7/02; H02J 17/00

(52) U.S. Cl. CPC H02J 5/005; H02J 17/00; H02J 7/025

(57) ABSTRACT

The disclosure features transmitters for wireless power transfer that include first and second coils each having at least one loop extending in a first plane and a controller configured to drive the first and second coils with electrical currents during operation of the transmitter, where the controller is configured so that during operation of the transmitter: in a first mode of operation, the controller drives the first and second coils to generate a magnetic field having a dipole moment that is parallel to the first plane to wirelessly transmit power to first and second receivers; and in a second mode of operation, the controller drives at least one of the first and second coils to generate a magnetic field having a dipole moment that is orthogonal to the first plane to wirelessly transmit power to a third receiver.

### CROSS-REFERENCE TO RELATED APPLICATIONS

This application claims priority to U.S. Provisional Patent Application No. 62/021,925, filed on Jul. 8, 2014, the entire contents of which are incorporated herein by reference.

### TECHNICAL FIELD

This disclosure relates to wireless power transfer.

### BACKGROUND

Energy can be transferred from a power source to a receiving device using a variety of techniques such as radiative (far-field) techniques. For example, radiative techniques using low-directionality antennas can transfer a small portion of the supplied radiated power, namely, that portion in the direction of, and overlapping with, the receiving device used for pick up. Using such methods, most of the energy is radiated away in directions other than the direction of the receiving device, and typically the transferred energy is insufficient to power or charge the receiving device. In another example of radiative techniques, directional antennas are used to confine and preferentially direct the radiated energy towards the receiving device. In this case, an uninterruptible line-of-sight and potentially complicated tracking and steering mechanisms are used.

Another approach is to use non-radiative (near-field) techniques. For example, techniques known as traditional induction schemes do not (intentionally) radiate power, but use an oscillating current passing through a primary coil, to generate an oscillating magnetic near-field that induces currents in a near-by receiving or secondary coil. Traditional induction schemes can transfer modest to large amounts of power over very short distances. In these schemes, the offset tolerances between the power source and the receiving device are very small. Electric transformers and proximity chargers use these traditional induction schemes.

### SUMMARY

This disclosure relates to wireless power transfer systems that transfer power from a power transmitting apparatus to a power receiving apparatus. To achieve high power transfer efficiency, the power transmitting apparatus and/or the power receiving apparatus can include a magnetic component and a shield to facilitate the power transfer. One or more coils can be arranged on one side of the magnetic component while the shield is positioned on the other (opposite) side of the magnetic component. The systems disclosed herein can have a compact size, in that the distance from the one or more coils to the shield can be relatively small. For example, embodiments can be small enough to be placed on the ground beneath a vehicle (in the case of the power transmitting apparatus) or installed under the vehicle chassis (in the chase of the power receiving apparatus). Moreover, the power transmitting and/or power receiving apparatus can have low loss due to the arrangement of the coils, the magnetic component, and the shield, compared to losses that occur using other wireless power transfer methods.

The techniques disclosed herein can be used to drive currents in multiple coils included in a power transmitting apparatus. Particularly, a controller can be used to control the magnitude and phase of the driving currents of the multiple coils. This controllability in conjunction with the various arrangements of multiple coils disclosed herein can be used to transmit power to different types of power receiving apparatuses. Therefore, the power transmitting apparatus can transfer power efficiently to not only one type of power receiving apparatus but various types of power receiving apparatuses, which can differ depending on the specific vehicle that is being charged. In some embodiments, the controller can selectively drive a subset of the multiple coils depending on the size and location of the power receiving apparatus. This approach can reduce power consumption by reducing or eliminating unnecessary current flow in coils not efficiently being used for power transfer.

In a first aspect, the disclosure features systems for wireless power transfer, the systems including a first coil including at least one loop extending in a first plane, where the at least one loop encloses a first area on the first plane, and a second coil including at least one loop extending in a second plane, where the at least one loop encloses a second area on the second plane. A projection of the second area onto the first plane in a direction orthogonal to the second plane overlaps with the first area on the first plane.

Embodiments of the systems can include any one or more of the following features.

The first plane and the second plane can be parallel. The overlapping region of the projection of the second area with the first area can have an area of at least 10% of the first area.

The systems can include a controller configured drive currents in the first coil and the second coil. In some embodiments, the controller can be configured to drive currents in opposite circulating directions in the first and the second coils. In some embodiments, the controller can be configured to drive currents in a common circulating direction in the first and the second coils. The power transmitting apparatus can include a sensor configured to detect a type of a power receiving apparatus in proximity to the power transmitting apparatus and send a feedback signal to the controller, and the controller can be configured to adjust relative directions of currents in the first and the second coils based on the feedback signal.

The systems can further include a third coil including at least one loop extending in a third plane, where the at least one loop encloses a third area on the third plane, and a fourth coil including at least one loop extending in a fourth plane, where the at least one loop encloses a fourth area on the fourth plane. A projection of the fourth area onto the third plane in a direction orthogonal to the fourth plane overlaps with the third area on the third plane.

The first, second, third, and fourth coils can be arranged in a 2 by 2 rectangular array.

The first coil and the second coil can be spaced from one another along a first direction connecting centers of the first area and the projection of the second area on the first plane. The third coil and the fourth coil can be spaced from one another along a second direction connecting centers of the third area and the projection of the fourth area on the third plane. An angle between the first direction and the second direction can be in a range from 75° to 105°.

The systems can include a controller configured to drive currents in the first, second, third and fourth coils. The controller can be configured to drive currents in the first and the second coils in a first circulating direction and configured to drive currents in the third and fourth coils in a second circulating direction opposite the first circulating direction. The controller can be configured to drive currents in the first coil and the third coil with a phase difference of between 80° and 100°.

The controller can be configured to drive currents in the first and the second coils in opposite circulating directions and configured to drive currents in the third and fourth coil in a common circulating direction. The controller can be configured to adjust relative magnitudes of currents flowing through the first coil and the third coil based on a feedback signal from a sensor.

The systems can include a power transmitting apparatus that includes the first, second, third, and fourth coils. The systems can include a sensor configured to detect an alignment between the power transmitting apparatus and a power receiving apparatus, and to send a feedback signal to the controller.

The systems can include multiple additional coils, where the first, second, and multiple additional coils are positioned to form a M by N rectangular array of coils, and where M≧3 and N≧3. The systems can include a controller configured to activate only a subset of the M by N coils to generate a magnetic field distribution. The controller can be configured to activate the subset of coils by circulating electrical currents through only the coils in the subset. In some embodiments, the controller can be configured to activate the subset of coils by tuning resonant frequencies of coils that are not in the subset away from a frequency of electrical currents circulated by the controller through the coils that are in the subset. In some embodiments, the controller can be configured to tune the resonant frequencies of the coils that are not in the subset by adjusting variable capacitors connected to each of the coils. The systems can include a sensor configured to detect a size of a power receiving apparatus of a vehicle and to transmit a feedback signal to the controller. The controller can be configured to adjust a number of coils in the subset based on the feedback signal.

In another aspect, the disclosure features methods for wirelessly transferring power from a power transmitting apparatus to a power receiving apparatus. The methods include circulating a first electrical current in a first coil of the power transmitting apparatus, circulating a second electrical current in a second coil of the power transmitting apparatus, and positioning the power receiving apparatus so a magnetic field generated by the first and second electrical currents in the power transmitting apparatus induces an electrical current in the power receiving apparatus. The first coil includes at least one loop extending in a first plane and enclosing a first area in the first plane, and the second coil includes at least one loop extending in a second plane and enclosing a second area in the second plane. A projection of the second area onto the first plane in a direction orthogonal to the second plane overlaps with at least a portion of the first area.

Embodiments of the methods can include any one or more of the following features.

The first plane and the second plane can be parallel. The overlapping region of the projection of the second area with at least a portion of the first area can have an area of at least 10% of the first area.

The first electrical current can be circulated in a first circulation direction and the second electrical current can be circulated in a second circulation direction. In some embodiments, the first and second circulation directions are in the same direction. In some embodiments, the first circulation direction is opposite to the second circulation direction. The methods can include adjusting the relative magnitudes of the first and second electrical currents. The methods can include adjusting the relative phase of the first and second electrical currents to be between 0° and 180°.

The methods can include measuring information about the power receiving apparatus using a sensor, and adjusting at least one of the first and second circulation directions based on the measured information.

The methods can include circulating a third electrical current in a third coil of the power transmitting apparatus, circulating a fourth electrical current in a fourth coil of the power transmitting apparatus, and positioning the power receiving apparatus so a magnetic field generated by the first, second, third, and fourth electrical currents in the power transmitting apparatus induces an electrical current in the power receiving apparatus. The third coil can include at least one loop extending in a third plane and enclosing a third area in the third plane. The fourth coil can include at least one loop extending in a fourth plane and enclosing a fourth area in the fourth plane. A projection of the fourth area onto the third plane in a direction orthogonal to the fourth plane can overlap with at least a portion of third area.

The first, second, third, and fourth coils can be arranged in a 2 by 2 rectangular array.

The first coil and the second coil can be spaced from one another along a first direction connecting centers of the first area and the projection of the second area on the first plane. The third coil and the fourth coil can be spaced from one another along a second direction connecting centers of the third area and the projection of the fourth area on the third plane. An angle between the first direction and the second direction is in a range from 75° to 105°.

The methods can include driving currents in the first and the second coils in opposite circulating directions, and driving currents in the third and fourth coils in opposite circulating directions. The methods can include driving currents in the first coil and in the third coil with a phase difference of between 80° and 110°.

The methods can include driving currents in the first and second coils in opposite circulating directions, and driving currents in the third and fourth coils in a common circulating direction. The methods can include detecting an alignment between the power transmitting apparatus and the power receiving apparatus using a sensor, and generating a feedback signal based on the detected alignment. The methods can include adjusting the relative magnitudes of the first and third currents based on the feedback signal.

The first and second coils can form a portion of a rectangular array of coils. The methods can include selecting at least one additional coil in addition to the first and second coils from among the rectangular array of coils to form a subset of coils of the rectangular array. The methods can include circulating electrical currents through each of the at least one additional coil.

The methods can further include tuning resonant frequencies of each of the coils in the rectangular array that are not part of the subset away from a frequency of the first electrical current, a frequency of the second electrical current, and frequencies of the circulating electrical currents through each of the at least one additional coil. Tuning resonant frequencies of each of the coils that are not part of the subset can include adjusting variable capacitors connected to each of the coils.

The methods can include detecting information about a size of the power receiving apparatus, and generating a feedback signal representing the measured information about the size of the power receiving apparatus. The methods can further include adjusting the selection of coils that form the subset based on the feedback signal.

In a further aspect, the disclosure features transmitters for wireless power transfer that include a first coil featuring at least one loop extending in a first plane, where the first coil encloses a first area in the first plane, a second coil featuring at least one loop extending in the first plane, where the second coil encloses a second area in the first plane adjacent to the first area, and a controller configured to drive the first and second coils with electrical currents during operation of the transmitter, where the controller is configured so that during operation of the transmitter: in a first mode of operation, the controller drives the first and second coils to generate a magnetic field having a dipole moment that is parallel to the first plane to wirelessly transmit power to first and second receivers; and in a second mode of operation, the controller drives at least one of the first and second coils to generate a magnetic field having a dipole moment that is orthogonal to the first plane to wirelessly transmit power to a third receiver.

Embodiments of the transmitters can include any one or more of the followings features.

The second area can overlap at least 10% of the first area in the first plane. In the first mode of operation, the controller can be configured to drive the first coil with an electrical current in a first circulating direction in the first plane, and to drive the second coil with an electrical current in a second circulating direction in the first plane opposite to the first circulating direction. In the second mode of operation, the controller can be configured to drive the first coil with an electrical current in a first circulating direction in the first plane, and to drive the second coil with an electrical current in the first circulating direction in the first plane.

The transmitters can include a sensor configured to determine information about which of the first, second, and third receivers is positioned in proximity to the transmitters and to transmit a signal to the controller that includes the information, where the controller is configured to operate in either the first or second mode based on the information.

The transmitters can include a third coil featuring at least one loop extending in the first plane, where the third coil encloses a third area in the first plane, and a fourth coil featuring at least one loop extending in the first plane, where the fourth coil encloses a fourth area in the first plane. The first, second, third, and fourth coils can be arranged in a 2 by 2 rectangular array in the first plane. The first coil and the second coil can be spaced from one another along a first direction connecting centers of the first area and the second area in the first plane, the third coil and the fourth coil can be spaced from one another along a second direction connecting centers of the third area and the fourth area in the first plane, and an angle between the first direction and the second direction can be in a range from 75° to 105°.

During operation of the transmitters, the controller can be configured to drive each of the first, second, third, and fourth coils with electrical currents. During operation of the transmitters, the controller can be configured to drive the first and second coils with electrical currents in a first circulating direction in the first plane, and to drive the third and fourth coils with electrical currents in a second circulating direction in the first plane opposite to the first circulating direction. During operation of the transmitters, the controller can be configured to drive the first and third coils with oscillating electrical currents having a phase difference of between 80° and 100°. During operation of the transmitters, the controller can be configured to drive the first coil with an electrical current in a first circulating direction in the first plane, to drive the second coil with an electrical current in a second circulating direction in the first plane opposite to the first circulating direction, and to drive the third and fourth coils with electrical currents in a common circulating direction in the first plane. The common circulating direction can correspond to the first circulating direction. The common circulating direction can correspond to the second circulating direction.

The transmitters can include a sensor configured to determine information about a proximity of each of the receivers to the transmitters, and to transmit a signal comprising the information to the controller. During operation of the transmitters, the controller can be configured to adjust magnitudes of electrical currents used to drive the first coil and the third coil based on the information.

The transmitters can include multiple additional coils each featuring at least one loop extending in the first plane, where the first, second, and multiple additional coils are positioned to form a M by N rectangular array of coils in the first plane, and where M≧3 and N≧3. The controller can be configured to selectively activate a subset of the M by N array of coils during operation of the transmitters to generate a magnetic field distribution to wirelessly transmit power to at least one of the first, second, and third receivers. The controller can be configured to selectively activate the subset of the M by N array of coils during operation of the transmitters by selectively circulating electrical currents only through coils in the array corresponding to the subset.

The controller can be configured to selectively activate the subset of the M by N array of coils during operation of the transmitters by tuning resonant frequencies of coils in the M by N array that are not in the subset away from a frequency of oscillating electrical currents that are circulated by the controller through coils in the array corresponding to the subset. The controller can be configured to tune the resonant frequencies of the coils that are not in the subset during operation of the transmitters by adjusting variable capacitors connected to each of the coils.

The transmitters can include a sensor configured to detect a size of at least one of the first, second, and third receivers, and to transmit a signal that includes information about the size to the controller. The controller can be configured to adjust which members of the M by N array of coils form the subset based on the size information.

Embodiments of the systems, methods, and transmitters can also include any other features disclosed herein, including features disclosed in connection with other systems, methods, and transmitters, in any combination as appropriate.

Unless otherwise defined, all technical and scientific terms used herein have the same meaning as commonly understood by one of ordinary skill in the art to which this disclosure belongs. In case of conflict with publications, patent applications, patents, and other references mentioned or incorporated herein by reference, the present disclosure, including definitions, will control. Any of the features described above may be used, alone or in combination, without departing from the scope of this disclosure. Other features, objects, and advantages of the systems and methods disclosed herein will be apparent from the following detailed description and figures.

### DESCRIPTION OF DRAWINGS

FIG. 1 is a schematic diagram of a wireless power transfer system.

FIG. 2 is a schematic diagram of an example of a power transmitting apparatus.

FIGS. 3A-3D are schematic diagrams of the power transmitting apparatus shown in FIG. 2 in different perspectives.

FIG. 4A is an image of an example of a frame used to hold a coil.

FIGS. 4B and 4C are images of an example of a frame used to hold a magnetic component.

FIGS. 5A and 5B are schematic diagrams of another example of a power transmitting apparatus.

FIG. 5C is a schematic diagram of another example of a power transmitting apparatus.

FIG. 6A is a schematic diagram of an example of a power transmitting apparatus including two coils.

FIG. 6B is an image of an example of a power transmitting apparatus implementing the characteristics described in relation to FIG. 6A.

FIGS. 7A-C are schematic diagrams showing examples of various arrangements of power transmitting and receiving apparatuses.

FIG. 7D is a schematic diagram of a perspective view of the power receiving apparatus shown in FIG. 7C.

FIGS. 8A and 8B are schematic diagrams of example coil arrangements including two coils.

FIGS. 9A-9B are schematic diagrams showing controlled current flow to drive the coil arrangement shown in FIG. 8A.

FIGS. 10A and 10B are schematic diagrams of other examples of coil arrangements.

FIGS. 11A-11C are schematic diagrams of an example of a coil arrangement using three coils.

FIG. 12A is a schematic diagram of an example of a coil arrangement including four coils.

FIG. 12B is a schematic diagram of an example of a coil arrangement including a 6 by 5 array of coils.

FIG. 13 is a schematic diagram of an example of a power transfer system for charging a vehicle.

FIG. 14 is a flow chart that includes a series of steps for wirelessly transferring power using a power transmitting apparatus including multiple coils.

FIG. 15 is a schematic diagram of a computing device.

Like reference numbers and designations in the various drawings indicate like elements.

### DETAILED DESCRIPTION

### Introduction

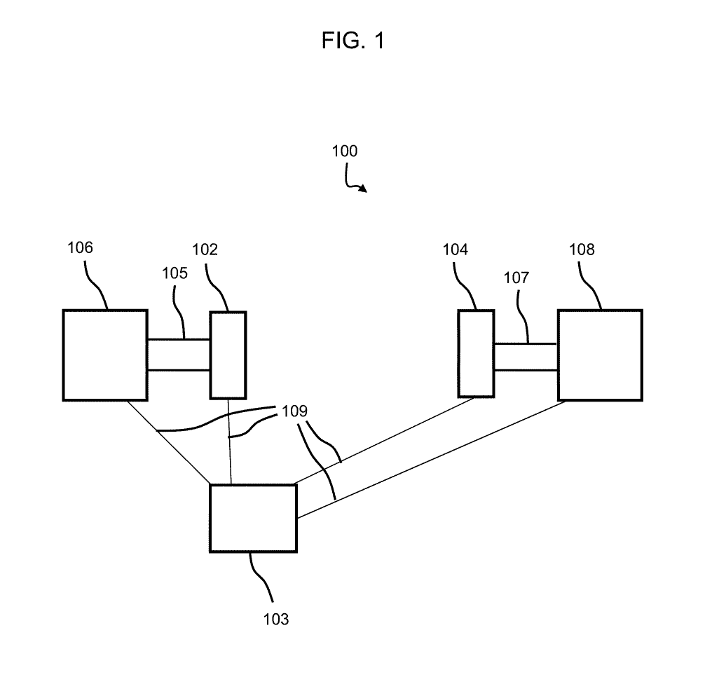

FIG. 1 is a schematic diagram of a wireless power transfer system 100. System 100 includes a power transmitting apparatus 102 and a power receiving apparatus 104. Power transmitting apparatus 102 is coupled to power source 106 through a coupling 105. In some embodiments, coupling 105 is a direct electrical connection. In certain embodiments, coupling 105 is a non-contact inductive coupling. In some embodiments, coupling 105 can include an impedance matching network (not shown in FIG. 1). Impedance matching networks and methods for impedance matching are disclosed, for example, in commonly owned U.S. patent application Ser. No. 13/283,822, published as US Patent Application Publication No. 2012/0242225, the entire contents of which are incorporated herein by reference.

In similar fashion, power receiving apparatus 104 is coupled to a device 108 through a coupling 107. Coupling 107 can be a direct electrical connection or a non-contact inductive coupling. In some embodiments, coupling 107 can include an impedance matching network, as described above.

In general, device 108 receives power from power receiving apparatus 104. Device 108 then uses the power to do useful work. In some embodiments, for example, device 108 is a battery charger that charges depleted batteries of a vehicle (e.g., car, truck, etc.) The techniques disclosed herein can be implemented where device 108 is a lighting device that uses received power to illuminate one or more light sources or an electronic device such as a communication device (e.g., a mobile telephone) or a display. In some embodiments, device 108 is a medical device which can be implanted in a patient.

During operation, power transmitting apparatus 102 is configured to wirelessly transmit power to power receiving apparatus 104. In some embodiments, power transmitting apparatus 102 can include one or more source coils, which can generate oscillating fields (e.g., electric, magnetic fields) when electrical currents oscillate within the one or more source coils. The generated oscillating fields can couple to power receiving apparatus 104 and provide power to the power receiving apparatus 104 through the coupling. To achieve coupling between power transmitting apparatus 102 and power receiving apparatus 104, the power receiving apparatus 104 can include one or more receiver coils. The oscillating fields can induce oscillating currents within the one or more receiver coils. In some embodiments, either or both of the source and receiver coils can be resonant. In certain embodiments, either or both of the source and receiver coils can be non-resonant so that the power transfer is achieved through non-resonant coupling.

In certain embodiments, the system 100 can include a power repeating apparatus (not shown in FIG. 1). The power repeating apparatus can be configured to wirelessly receive power from the power transmitting apparatus 102 and wirelessly transmit the power to the power receiving apparatus 104. The power repeating apparatus can include similar elements described in relation to the power transmitting apparatus 102 and the power receiving apparatus 104 above.

System 100 can include an electronic controller 103 configured to control the power transfer in the system 100, for example, by directing electrical currents through coils of the system 100. In some embodiments, the electronic controller 103 can tune resonant frequencies of resonators included in the system 100, through coupling 109. The electronic controller 103 can be coupled to one or more elements of the system 100 in various configurations. For example, the electronic controller 103 can be only coupled to power source 106. The electronic controller 103 can be coupled to power source 106 and power transmitting apparatus 102. The electronic controller 103 can be only coupled to power transmitting apparatus 102. In some embodiments, coupling 109 is a direct connection. In certain embodiments, coupling 109 occurs via wireless communication (e.g., radio-frequency, Bluetooth communication). The coupling 109 between the electronic controller 103 can depend on respective one or more elements of the system 100. For example, the electronic controller 103 can be directly connected to power source 106 while wirelessly communicating with power receiving apparatus 104.

In some embodiments, the electronic controller can configure the power source 106 to provide power to the power transmitting apparatus 102. For example, the electronic controller can increase the power output of the power source 106, thereby increasing the power sent to the power transmitting apparatus 102. The power output can be at an operating frequency which is used to generate oscillating fields by the power transmitting apparatus 102.

In certain embodiments, the electronic controller 103 can tune a resonant frequency of a resonator in the power transmitting apparatus 102 and/or a resonant frequency of a resonator in the power receiving apparatus 104. By tuning resonant frequencies of resonators relative to the operating frequency of the power output of the power source 106, the efficiency of power transfer from the power source 106 to the device 108 can be controlled. For example, the electronic controller 103 can tune the resonant frequencies of power transmitting apparatus 102 and power receiving apparatus 104 to be substantially the same (e.g., within 0.5%, within 1%, within 2%) to increase the efficiency of power transfer.

In some embodiments, the electronic controller 103 can tune the resonant frequencies by adjusting capacitance values of respective resonators in power transmitting apparatus 102 and/or power receiving apparatus 104. To achieve this, for example, the electronic controller 103 can adjust a capacitance of a capacitor connected to a coil in a resonator. The adjustment can be based on a measurement of the resonant frequency by electronic controller and/or based on a communication signal transmitted from the apparatuses 102 and/or 104 to electronic controller 103 (e.g., transmitted wirelessly). In certain embodiments, the electronic controller 103 can tune the operating frequency to be substantially the same (e.g., within 0.5%, within 1%, within 2%) as the resonant frequencies of the resonators. In some embodiments, the operating frequency can be tuned to be different from the resonant frequency of at least one resonator by an amount in a range from 7% to 13% (e.g., 10% to 15%, 13% to 19%).

In some embodiments, the electronic controller 103 can control an impedance matching network in the system 100 to adjust impedance matching conditions in the system 100, and thereby control the efficiency of power transfer. For example, the electronic controller 103 can tune capacitances of capacitors or networks of capacitors included in the impedance matching network connected between power transmitting apparatus 102 and power source 106. The optimum impedance conditions can be calculated internally by the electronic controller 103 or can be received from an external device.

In some embodiments, wireless power transfer system 100 can utilize a source resonator to wirelessly transmit power to a receiver resonator. For example, power transmitting apparatus 102 can include a source resonator that features a source coil, and power receiving apparatus 104 can include a receiver resonator that features a receiver coil. Power can be wirelessly transferred between the source resonator and the receiver resonator.

In this disclosure, “wireless energy transfer” from one coil (e.g., a resonator coil) to another coil (e.g., another resonator coil) refers to transferring energy to do useful work (e.g., electrical work, mechanical work, etc.) such as powering electronic devices, vehicles, lighting a light bulb or charging batteries. Similarly, “wireless power transfer” from one coil (e.g., resonator coil) to another resonator (e.g., another resonator coil) refers to transferring power to do useful work (e.g., electrical work, mechanical work, etc.) such as powering electronic devices, vehicles, lighting a light bulb or charging batteries. Both wireless energy transfer and wireless power transfer refer to the transfer (or equivalently, the transmission) of energy to provide operating power that would otherwise be provided through a wired connection to a power source, such as a connection to a main voltage source. With the above understanding, the expressions “wireless energy transfer” and “wireless power transfer” are used interchangeably in this disclosure. It should also be understood that, “wireless power transfer” and “wireless energy transfer” can be accompanied by the transfer of information; that is, information can be transferred via an electromagnetic signal along with the energy or power to do useful work.

### Power Transmitting and Receiving Apparatuses

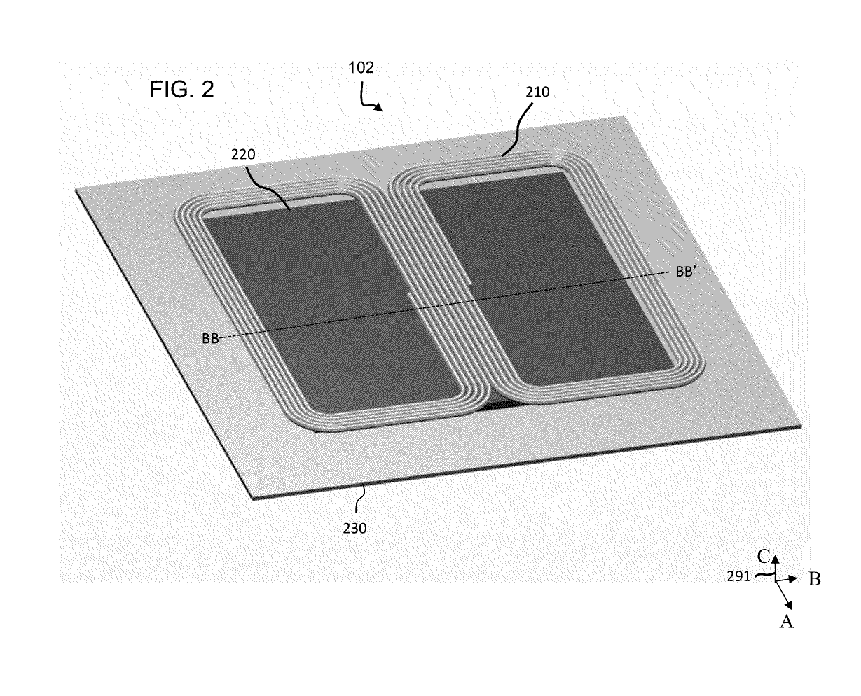

FIG. 2 is a schematic diagram of an example of a power transmitting apparatus 102 including a coil 210, a magnetic component 220 and a shield 230 according to coordinate 291. The coil 210 includes a plurality of loops and can be connected to a capacitor (not shown). The coil 210 can be formed of a first conductive material. In some embodiments, the coil 210 can be formed of litz wire. For example, litz wire can be used for operation at frequencies of lower than 1 MHz (e.g., 85 kHz). In certain embodiments, the coil 210 can be formed of a solid core wire or one or more conducting layers (e.g., copper layers) on (or in) a printed circuit board (PCB). For example, solid core wire or conducting layers can be used at operation frequencies of 1 MHz or higher. The magnetic component 220 is positioned between the coil 210 and the shield 230. Thus, the coil 210 is positioned on one side of the magnetic component 220 and the shield 230 is positioned on the other opposite side of the magnetic component 220. In general, the magnetic component 220 guides magnetic flux induced by the plurality of loops of the coil 210. The presence of the magnetic component 220 can lead to an increase of a magnetic flux density generated by the coil 210 in a region adjacent to the coil 210 when oscillating electrical currents circulate in the coil 210, compared to the case without the magnetic component 220.

In some embodiments, the magnetic component 220 can be formed from multiple magnetic elements (e.g., ferrite tiles). One or more gaps (not shown in FIG. 2) can be formed between the multiple magnetic elements, and can be filled with dielectric material such as adhesive. In some embodiments, the multiple magnetic elements can be contained in a holder made from thermally conducting and electrically insulating materials (e.g., plastic, Teflon®, aluminum oxide, aluminum nitride, etc.)

The shield 230 (e.g., a sheet of electrically conductive material) is typically positioned adjacent to the source resonator. The shield 230 can be formed of a second conductive material. For example, the shield 230 can be formed from a sheet of material such as copper, silver, gold, iron, steel, nickel and/or aluminum. Typically, the shield 230 acts to shield the resonator from loss-inducing objects (e.g., metallic objects). Further, in some embodiments, the shield 230 can increase coupling of the source resonator to another resonator by guiding magnetic field lines in the vicinity of the source resonator. For example, energy loss from aberrant coupling to loss-inducing objects can be reduced by using the shield 230 to guide magnetic field lines away from the loss-inducing objects. The shield 230 can include one or more depressions (not shown in FIG. 2) that can be aligned with gaps of the magnetic component 220 to reduce losses of generated magnetic fields. Shields with one or more depressions and magnetic components with one or more gaps are described, for example, in commonly owned U.S. patent application Ser. No. 14/688,025, filed on Apr. 16, 2015, the entire contents of which are incorporated herein by reference.

Magnetic components can include magnetic materials. Typical magnetic materials that are used in the magnetic components disclosed herein include materials such as manganese-zinc (MnZn) and nickel-zinc (NiZn) ferrites.

While these materials are generally available in small sizes, some applications for wireless power transfer utilize magnetic components with a large areal size. For example, a car battery charging application may use magnetic components of large areal size (e.g., 30 cm×30 cm) to transfer high power of 1 kW or more (e.g., 2 kW or more, 3 kW or more, 5 kW or more, 6 kW or more).

In some embodiments, a magnetic component in the form of a single monolithic piece of material can be utilized when such a piece of material is available. In some embodiments, it can be difficult and/or expensive to manufacture a monolithic piece of magnetic component material such as MnZn or NiZn ferrites with a large areal size (e.g., 30 cm×30 cm) for high power transfer. Moreover, MnZn and NiZn ferrites can be brittle, and accordingly, large-area pieces of these materials can be highly susceptible to breakage. To overcome such difficulties when fabricating the magnetic components disclosed herein, ferrite materials can be manufactured in pieces of small areal size (e.g., 5 cm×5 cm), and several such pieces can be joined together to form a larger combined magnetic component. These smaller magnetic elements can behave functionally in a manner very similar to a larger magnetic element when they are joined.

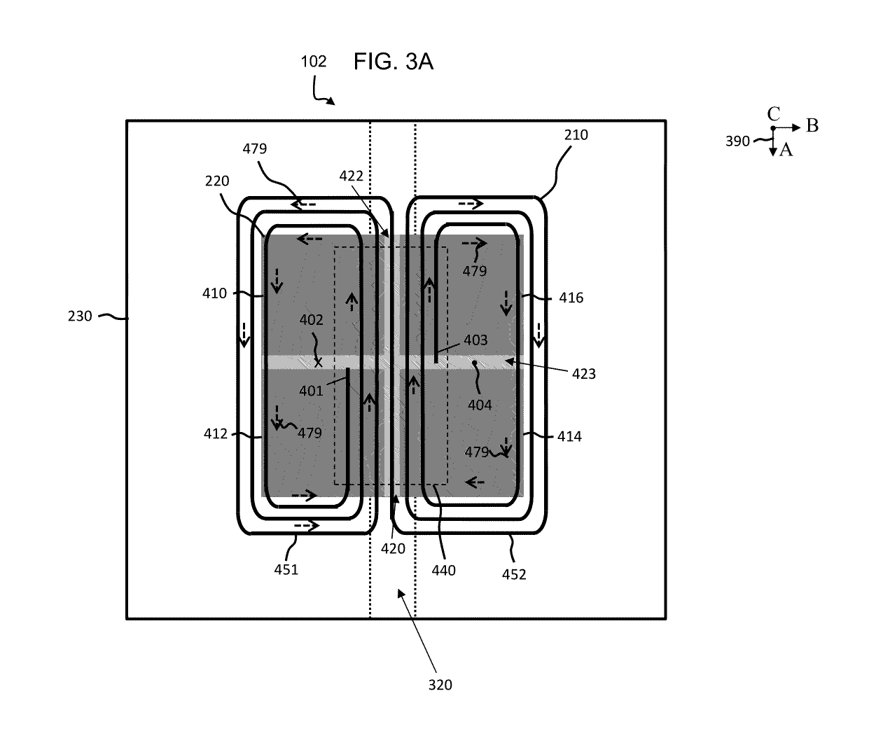

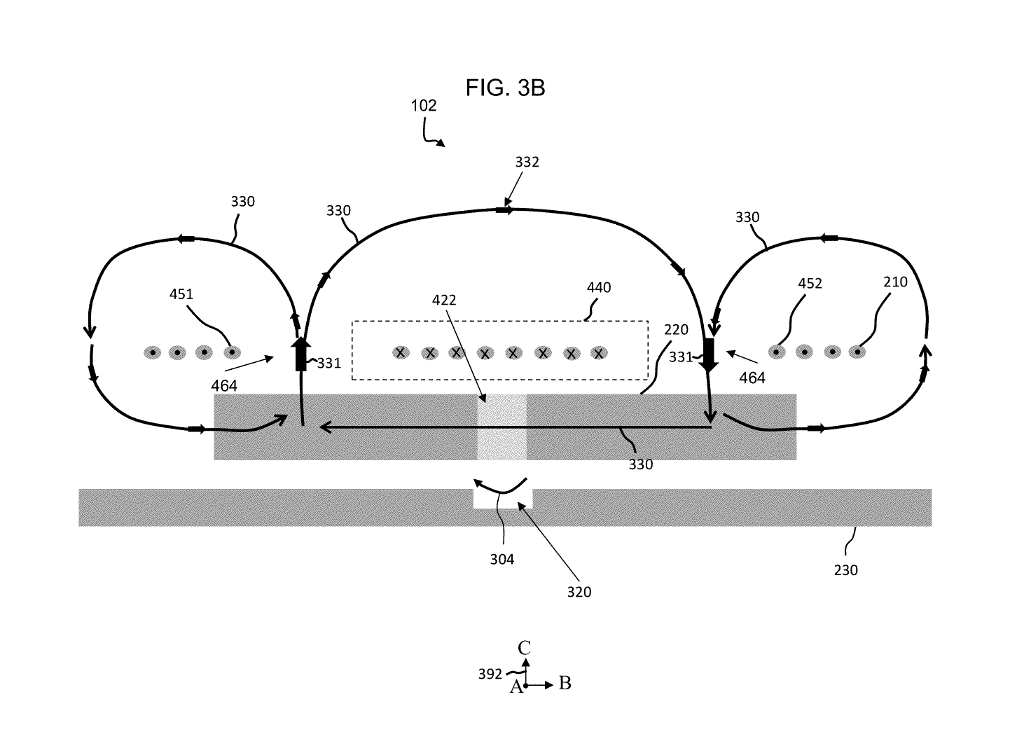

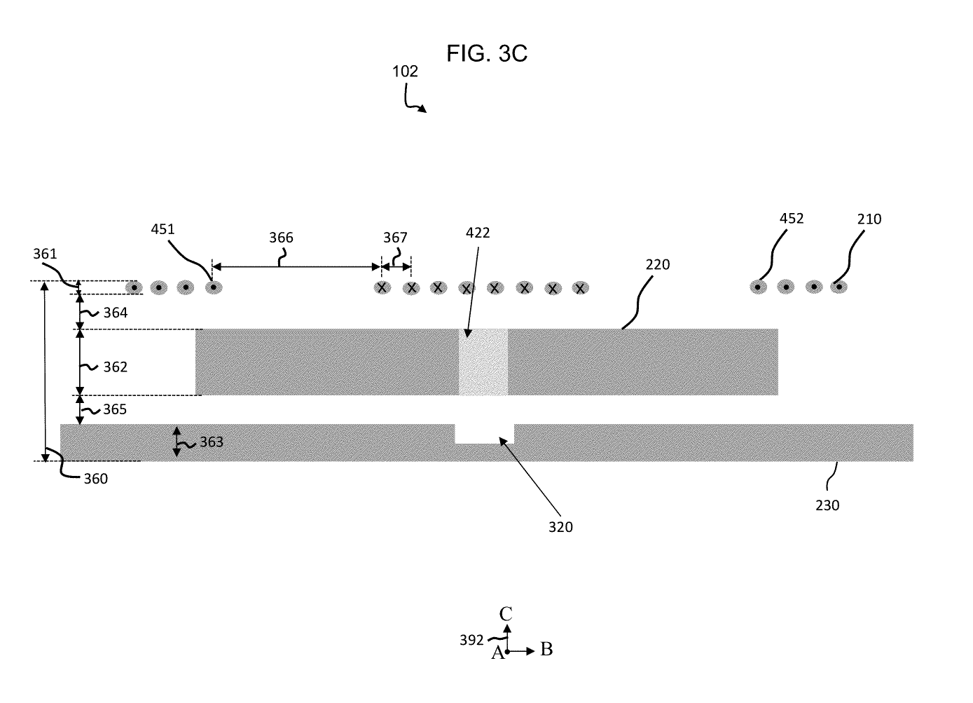

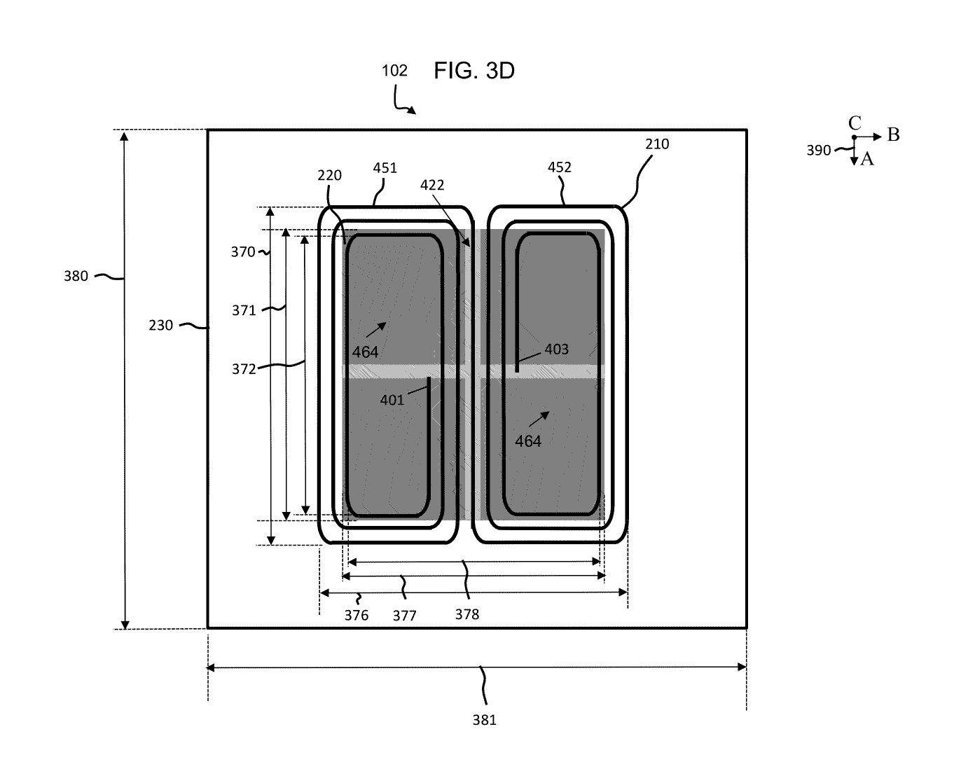

Additional aspects of the power transmitting apparatus 102 of FIG. 2 are described in further detail in connection with subsequent figures. In power transmitting apparatus 102 shown in FIG. 3A, the number of windings is less than in FIG. 2 for clarity of illustration. Coordinate 390 is the local coordinate of the magnetic component 220.

In FIG. 3A, coil 210 is positioned above magnetic component 220. The magnetic component 220 is displaced from shield 230 in the C-direction, with no portion of the coil 210 in between the magnetic component 220 and the shield 230 (e.g., without coil 210 extending in the C-direction). This configuration of the coil 210 can provide a compact power transmitting apparatus because the coil 210 does not take up space between the magnetic component 220 and the shield 230.

The shield 230 lies in a plane nominally parallel to the plane of coil 210. In FIG. 3A, magnetic component 220 also lies in a plane nominally parallel to the plane of coil 210. In certain embodiments, the magnetic component 220 lies in a plane substantially parallel (e.g., within 3°, within 5°, within 10°, within 15°) to the plane of coil 210.

In FIG. 3A, the magnetic component 220 includes four magnetic elements 410, 412, 414 and 416 (e.g., ferrite tiles) each shaped as a rectangular slab. The magnetic elements are joined together with a dielectric material 420 to form the magnetic component 220, which extends in a plane parallel to the A-B plane. The dielectric material 420 can be an adhesive material which bonds the four magnetic elements 410, 412, 414 and 416 together. By fabricating a magnetic component from smaller magnetic elements, large-size magnetic components can be produced more easily and at lower cost compared to fabrication methods that rely on producing monolithic elements. By using multiple small magnetic elements to form a larger magnetic component, the size of the magnetic component can generally be selected as desired for a particular apparatus. In some embodiments, the size of the magnetic component can have an area of 30 cm×30 cm or larger (e.g., 40 cm×40 cm or larger, 50 cm×50 cm or larger).

In some embodiments, the magnetic component 220 can be formed from a plurality of tiles, blocks, or pieces of magnetic component that are arranged together to form magnetic component 220. The plurality of tiles, blocks, or pieces can all be formed from the same type of magnetic material, or can be formed from two or more different types of magnetic materials. For example, in some embodiments, materials with different magnetic permeability can be located at different positions of the magnetic component 220. A dielectric material such as adhesive can be used to glue the different magnetic elements together. In some embodiments, magnetic elements can be in direct contact with one another. Irregularities in interfaces across which elements are in direct contact can lead to magnetic field hot spots. In some embodiments, the magnetic component 220 can include electrical insulator layers, coatings, strips, and/or adhesives for mitigating build-up of heat at irregular interfaces within the magnetic component 220.

Referring back to FIG. 3A, the magnetic component 220 includes gaps 422 and 423, which are formed between the magnetic elements 410, 412, 414 and 416. The discontinuities in the magnetic component 220 between adjacent magnetic elements define the gaps 422 and 423. The coil 210 has a plurality of loops which lie in the A-B plane, and includes windings 451 and 452. The windings 451 and 452 correspond to first and second pluralities of loops, respectively, of the coil 210. The winding 451 has an end 401 and connects to the winding 452, which has an end 403. Thus, the two windings 451 and 452 are continuously and electrically connected to each other. In this example, starting from the end 401, the winding 451 is concentrically wound around an axis 402 (starting from the innermost loop of winding 451 towards its outermost loop), which points into the drawing plane (i.e., in the negative C-direction in FIG. 3A) according to the right-hand rule convention, which is used through-out this disclosure. The C-direction is perpendicular to the A-direction and the B-direction.

Beginning from the portion of conductive material that connects windings 451 and 452, the winding 452 is concentrically wound around an axis 404 (starting from the outermost loop of winding 452 towards its innermost loop), which points out of the drawing plane (i.e., in the positive C-direction in FIG. 3A). Hence, the winding 451 is wound in an opposite direction to the winding 452 when measured from end 401 to end 403.

In this disclosure, the “x” notation (e.g., of axis 402) refers to a direction pointing into the drawing plane (i.e., negative C-direction in FIG. 3A) and the “dot” notation (e.g., of axis 404) refers to a direction pointing out of the drawing plane (i.e., positive C-direction in FIG. 3A). Dashed arrows 479 depict one example of current flow in the windings 451 and 452 at a given time.

Described in an alternative manner, the winding 451 can be said to be wound clock-wise starting from its innermost loop as seen towards the negative C-direction from the positive C-direction, and the winding 452 can be said to be wound clock-wise winding starting from its innermost loop as seen towards the negative C-direction from the positive C-direction. In other words, the two windings can be said to have the same winding directions when starting from their respective innermost loops towards their outermost loops.

The coil 210 is configured to generate oscillating magnetic fields and magnetic dipoles in the magnetic component 220, which oscillate substantially along the B-axis, when currents oscillate within the coil 210. The plurality of loops of the coil 210 defines a coil that is positioned in the A-B plane. More generally, the plurality of loops may form a flat portion of the coil 210 that is oriented at an angle to the A-B plane. For example, the angle can be within 20° or less (e.g., 15° or less, 10° or less, 5° or less). Generally, either or both of the axes 402 and 404 may point at an angle with respect to the C-direction. For example, the angle can be within 20° or less (e.g., 15° or less, 10° or less, 5° or less).

FIG. 3B is a schematic diagram showing a cross-sectional view of the power transmitting apparatus 102 along section line BB-BB′ in FIG. 2, according to coordinate 392. The number of windings differ from FIG. 3A for the sake of simplicity of depiction. At a given time as shown in FIG. 3B, the windings in center portion 440 have the driving current flowing into the drawing plane (i.e., in the negative A-direction) as indicated by the “x” notation. Other portions of windings 451 and 452 have currents flowing out of the drawing plane (i.e., in the positive A-direction) as indicated by the “dot” notation in FIG. 3B. The magnetic field lines 330 generated by the driving currents are drawn schematically and not to scale. In this example, when coil 210 generates a magnetic field within a gap 422 of magnetic component 220, portions of the magnetic field 304 extend below the gap 422. Because a depression 320 is formed in the shield 230, penetration of the magnetic field 304 into the shield 230 can be reduced or eliminated, thereby reducing energy loss.

FIG. 3C is a schematic diagram showing the power transmitting apparatus 102 described in FIG. 3B. For car charging applications using an operating frequency of about 85 kHz, litz wire can be used for coil 210. For example, the litz wire can be a 4400/44 litz wire having 4200 strands of 0.0508 mm diameter. More generally, the diameter 361 of the litz wire can be in a range from 2.5 mm to 3.5 mm (e.g., 3 mm to 4 mm, 3.5 mm to 4.5 mm, 4 mm to 5 mm, 4.5 mm to 5.5 mm, 5 mm to 6 mm, 5.5 mm to 6.5 mm, 6 mm to 7 mm), and each winding can be evenly separated by a distance 367 of about 3 mm to 4 mm (e.g., 3.5 mm to 4.5 mm, 4 mm to 5 mm, 4.5 mm to 5.5 mm, 5 mm to 6 mm, 5.5 mm to 6.5 mm).

In some embodiments, magnetic component 220 can have a thickness 362 of about 8 mm, and shield 230 can have a thickness 363 of about 4 mm. As will be described later, one or more frames made from thermally conducting and electrically insulating materials (e.g., plastic, Teflon®, aluminum oxide, aluminum nitride, etc.) can be used to hold the coil 210 and the magnetic component 220. These frames can have thicknesses, which determine distance 364 between the coil 210 and the magnetic component 220 and distance 365 between the magnetic component and the shield 230. For example, each of the distances 364 and 365 can be between 1 mm and 2 mm. In some embodiments, the distances 364 and 365 need not be the same, and can each be in a range from 0.75 mm to 1.25 mm (e.g., 1 mm to 1.5 mm, 1.25 mm to 1.75 mm, 1.5 mm to 2 mm, 1.75 mm to 2.25 mm). Length 360 is the distance between the furthest points of the coil 210 and shield 230 along the C-direction. In some embodiments, the length 360 can be 15 mm or less (e.g., 17 mm or less, 20 mm or less).

Referring next to FIG. 3D, various dimensions of the power transmitting apparatus 102 are shown in schematic form. The coil 210 has a length 370 in the A-direction and a length 376 in the B-direction. In some embodiments, each of the lengths 370 and 376 can be in a range from 25 cm to 35 cm (e.g., 30 cm to 40 cm, 35 cm to 45 cm, 40 cm to 50 cm, 45 cm to 55 cm, 60 cm to 70 cm). The two lengths need not be the same. For example, in some embodiments, one of the lengths can be about 472 mm while the other is about 500 mm. In some embodiments, the ratio of length 376 to length 370 can be between 1.5:1 to 2:1 (e.g., 1.75:1 to 2.25:1, 2:1 to 2.5:1, 2.25:1 to 2.75:1, 2.5:1 to 3:1, 2.75:1 to 3.25:1).

In certain embodiments, the width of gap 422 can be about 1 mm or less (e.g. about 0.6 mm or less, about 0.4 mm or less, about 0.2 mm or less). The magnetic component 220 can have a length 371 in the A-direction and a length 377 in the B-direction with a thickness of about 8 mm. For example, the thickness can be in a range from 6 mm to 7 mm (e.g., 6.5 mm to 7.5 mm, 7 mm to 8 mm, 7.5 mm to 8.5 mm, 8 mm to 9 mm). As an example, the lengths can be in range between 300 mm to 350 mm (e.g., 350 mm to 450 mm, 400 mm to 500 mm, 450 mm to 550 mm). As another example, each of the lengths 371 and 377 can be about 450 mm. The two lengths need not be the same. As a further example, in some embodiments, one of the lengths can be about 400 mm while the other can be about 450 mm.

In general, inner lengths 372 and 378 determine the area of openings 464 formed by the windings 451 and 452. Each of the lengths 372 and 378 can be about 350 mm. For example, the lengths can be in range from 200 mm to 300 mm (e.g., 250 mm to 350 mm, 300 mm to 400 mm). While in some embodiments lengths 372 and 378 are the same, in other embodiments they are different. In some embodiments, length 371 can be larger than length 370 and/or length 377 can be larger than length 376.

In some embodiments, length 371 can be smaller than length 370, and length 377 can be smaller than length 376 when there are no nearby lossy objects that are not effectively shielded by shield 230. In this case, length 371 can be chosen to be in a range within 3% (e.g., within 5%, within 10%, within 15%) of the average value of lengths 370 and 372. Length 377 can be chosen to be in a range within 3% (e.g., within 5%, within 10%, within 15%) of the average value of lengths 376 and 378.

The configuration shown in FIG. 3D can also be implemented for a power receiving apparatus 104. The size of a shield (e.g., made from a conductive material such as aluminum) in a power receiving apparatus can have lengths 380 and 381. In some embodiments, for example, each of the lengths 380 and 381 can be in a range from about 350 mm to 450 mm (e.g., 400 mm to 500 mm, 450 mm to 550 mm, 500 mm to 600 mm, 550 mm to 650 mm, 600 mm to 700 mm). The lengths 380 and 381 need not be the same. In some embodiments, the shield can have a thickness in a range from 3 mm to 4 mm (e.g., 3.5 mm to 4.5 mm, 4 mm to 5 mm, 4.5 mm to 5.5 mm, 5 mm to 6 mm). Magnetic component 220 can include a 2 by 2 array of ferrite tiles with lengths 371 and 377. Each of lengths 371 and 377 can be in a range from 100 mm to 200 mm (e.g., 150 mm to 250 mm, 200 mm to 300 mm, 250 mm to 350 mm). The lengths 371 and 377 need not be the same. Magnetic components can have a thickness in a range from 6 mm to 7 mm (e.g., 6.5 mm to 7.5 mm, 7 mm to 8 mm, 7.5 mm to 8.5 mm, 8 mm to 9 mm). In some embodiments, coil 210 can have a number of winding turns in a range from 3 to 5 turns (e.g., 4 to 7 turns, 5 to 8 turns, 6 to 9 turns). In some embodiments, as an example, coil 210 can have 6 turns of litz wire with lengths 370 and 376 being about 260 mm. In such a configuration, an inductance of the coil can be about 28.6 pH.

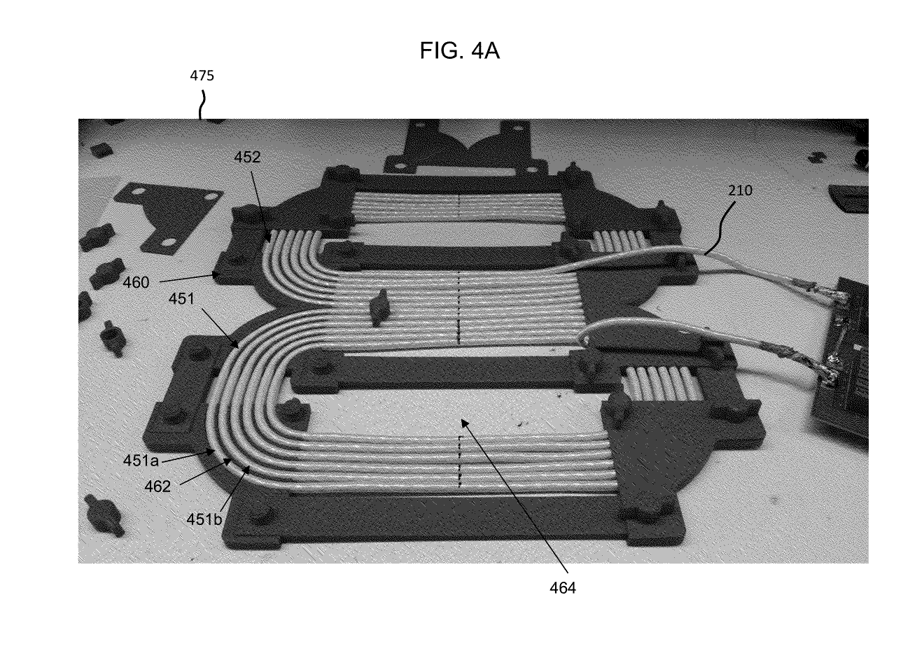

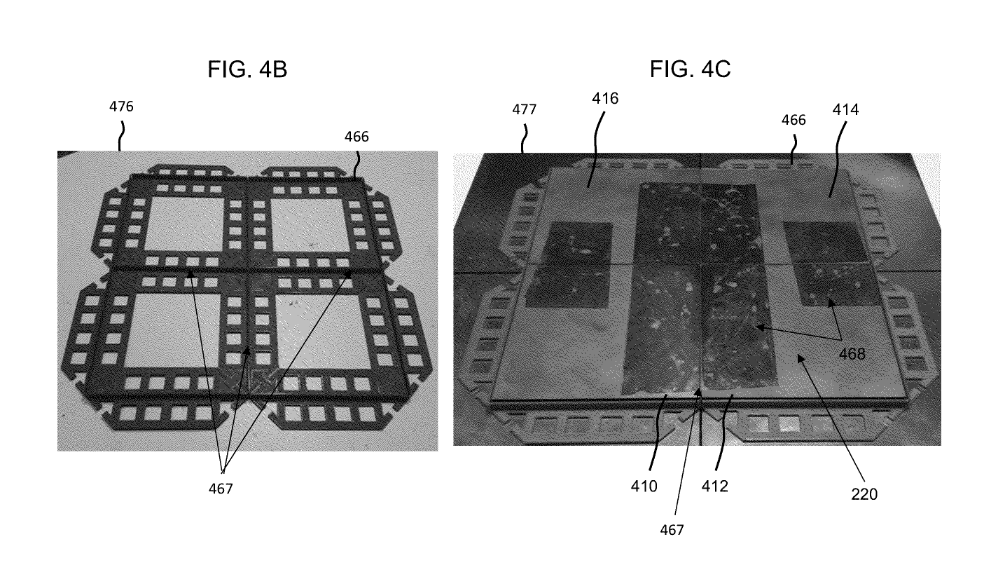

FIG. 4A is an image 475 of an apparatus that includes a frame 460 used to hold a coil 210, which shares certain characteristics in common with the embodiments of the preceding figures. Frame 460 can be manufactured, for example, using a three-dimensional (3D) printing machine. The frame 460 can have fixtures such as sidewall 462 that is used to hold and shape the curvature of windings 451 and 452 of coil 210. For example, image 475 shows a sidewall 462 positioned between outer most winding 451a and second outer most winding 451b. This sidewall 462 holds the outer most winding 451a and second outer most winding 451b in fixed position.

FIG. 4B is an image 476 of an example of a frame 466 used to hold multiple magnetic elements of a magnetic component 220, which can have one or more characteristics described in relation to the preceding figures. As shown in image 476, the frame 466 has four compartments separated by sidewalls 467. FIG. 4C is an image 476 showing the frame 466 with inserted magnetic elements 410-416. Each magnetic element is separated by sidewalls 467, which are about 0.4 mm thick. Tape 468 is also used to hold the magnetic elements 410-416 in place.

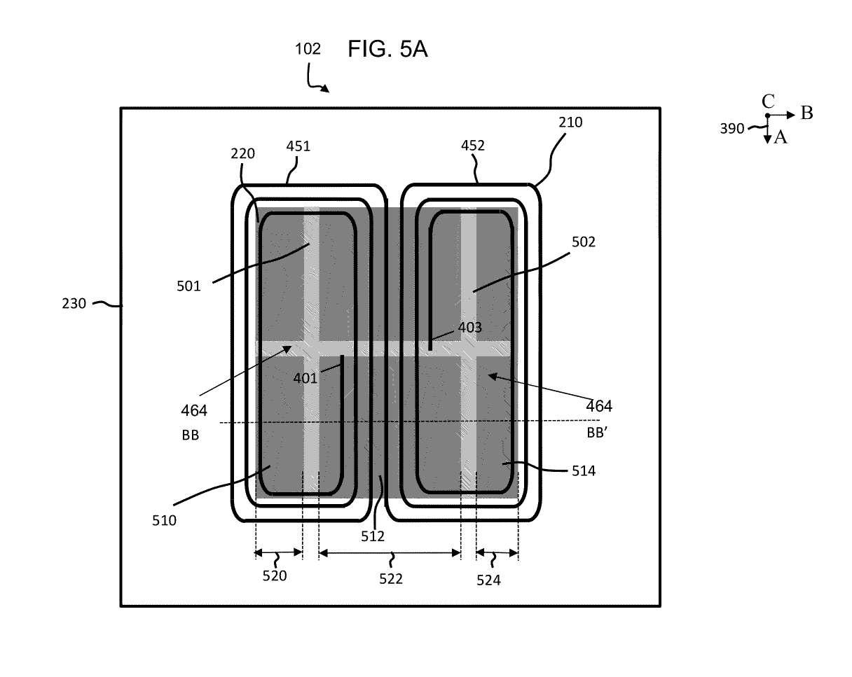

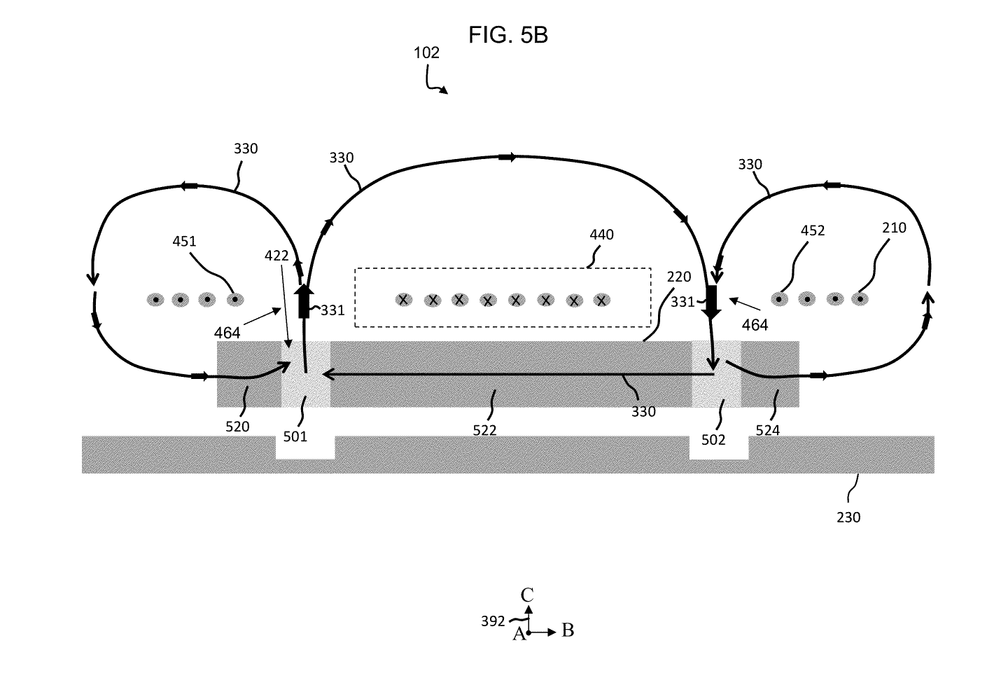

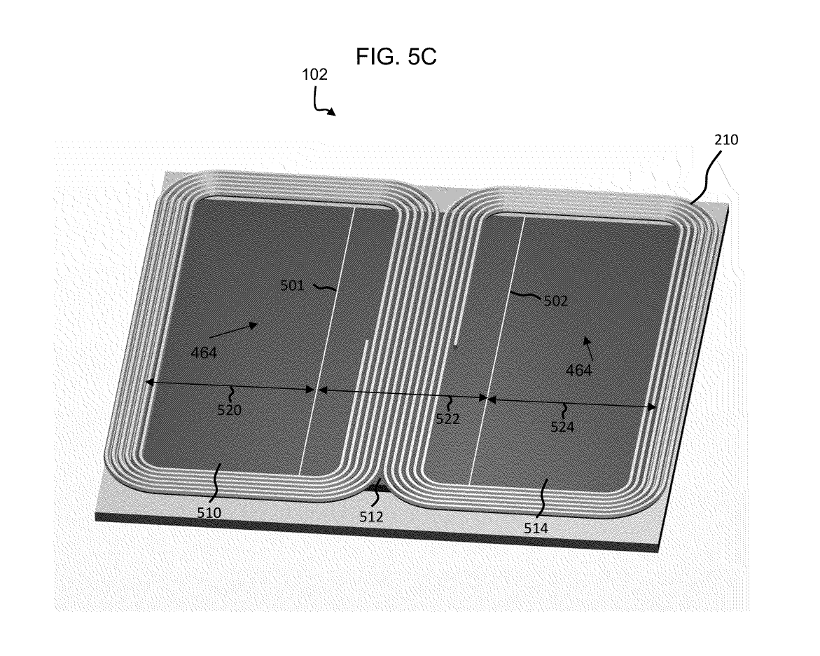

In FIGS. 4B and 4C, four magnetic elements in a 2 by 2 array were used to form magnetic component 220. More generally, magnetic component 220 can be formed as an array of any size consisting of magnetic elements, where the sizes of the magnetic elements can be the same or can differ from one another. As an example, FIG. 5A shows a schematic diagram of a power transmitting apparatus 102 including a 3 by 2 array of magnetic elements, which include elements 510, 512 and 514 arranged along the B-direction. The magnetic elements 510, 512 and 514 have lengths 520, 522 and 524, respectively. In particular, gap 501 between elements 510 and 512 and gap 502 between elements 512 and 514 are aligned with openings 464 of coil 210 formed by windings 451 and 452. FIG. 5B, which is a schematic cross-sectional diagram through section line BB-BB′ in FIG. 5A, shows the alignment between gaps 501 and 502 and the centers of openings 464 along the C-direction of coordinate 392. At a given time, currents in the coil 210 generate magnetic field lines 330. Gaps 501 and 502 are aligned with openings 464, where magnetic dipoles 331 are oriented perpendicular to magnetic component 220. This configuration can be advantageous when two gaps 501 and 502 are formed by combining magnetic elements in that most magnetic fields may point parallel to the edges of the magnetic elements that define the gaps 501 and 502, rather than perpendicular to the edges, and thereby reduce loss due to hot spots.

Gaps 501 and 502 are aligned with the centers of openings 464 in FIG. 5B. More generally, however, gaps 501 and/or 502 can be aligned with openings 464, but not necessarily with the centers of openings 464. As an example, FIG. 5C illustrates a schematic diagram of a power transmitting apparatus 102, where gaps 510 and 502 are aligned with openings 464, but not with the centers of openings 464.

Generally, the size of coil 210 in a power transmitting apparatus 102 can determine the spatial extent and shape of the generated magnetic field distribution. For example, when the coil 210 has larger lengths 370 and 376, the magnetic near-field distribution can decay over a longer length in the C-direction. However, in some embodiments, the length of coil 210 is limited by the dimensions of a vehicle. For example, the size of the chassis of the vehicle can limit the maximum size of the coil 210.

In some embodiments, power transmitting apparatus 102 may require an inductance of the coil 210 to be within a specific range to satisfy resonance frequency and impedance matching conditions of the power transmitting apparatus 102. Moreover, it can be advantageous to have a larger number of windings in the coil 210 to generate strong magnetic fields, and the larger number of windings can increase the inductance value of the coil 210. In some embodiments, power transmitting apparatus 102 can include two coils that provide a sufficient number of windings while having an inductance value according to the requirements of a power transmitting apparatus. The two coils can be connected in parallel in certain embodiments to lower the effective inductance value of the combination of the two coils.

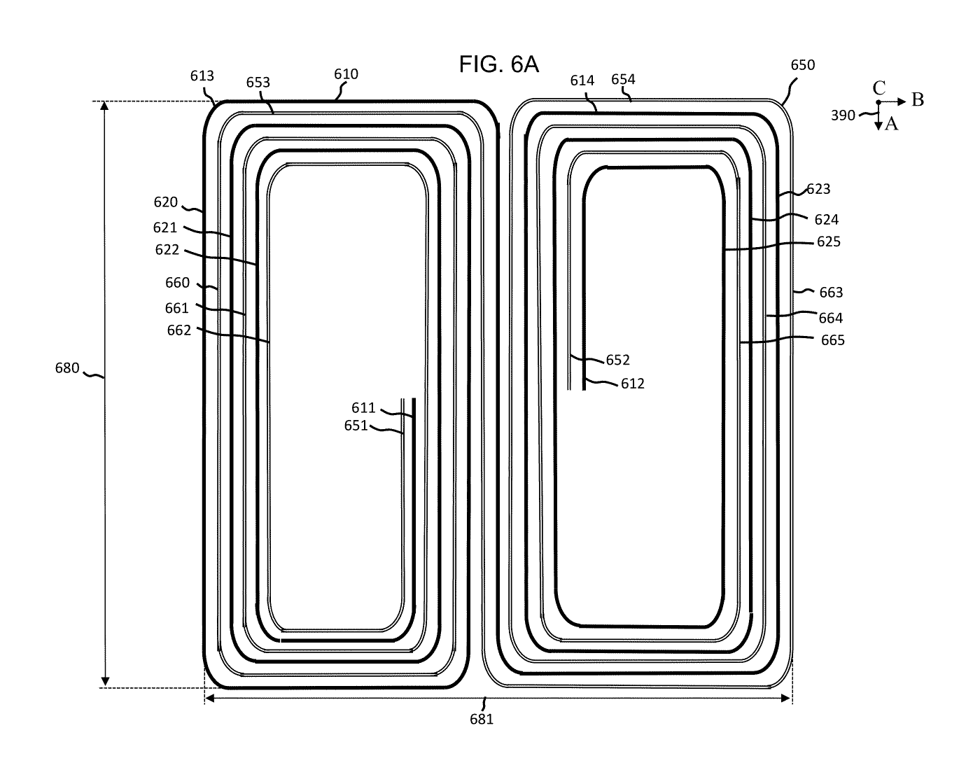

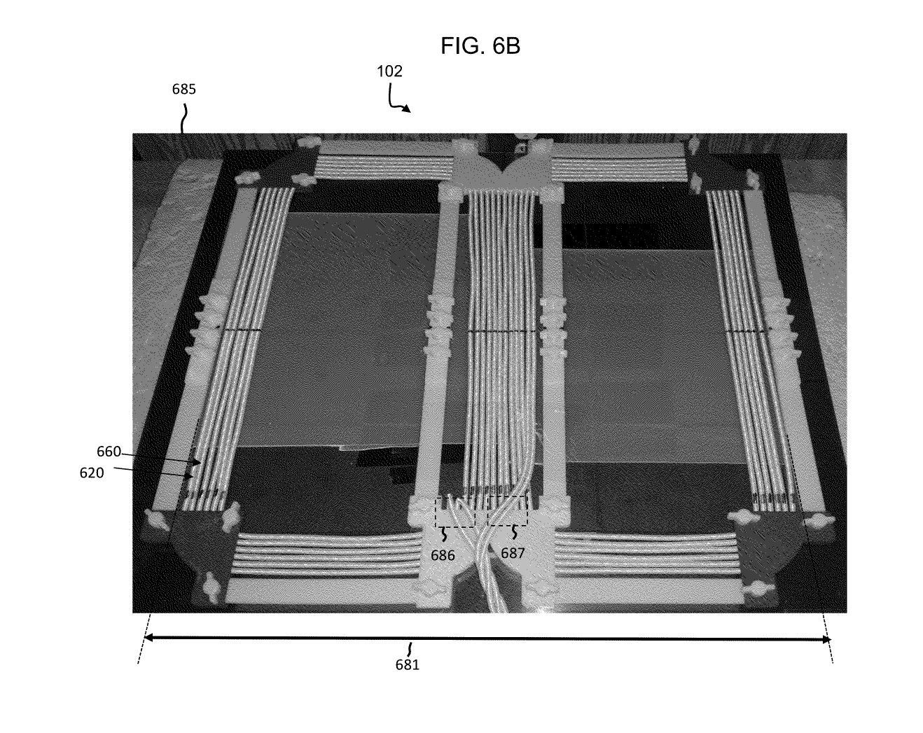

FIG. 6A is a schematic diagram showing coils 610 and 650. Coil 610 includes a winding 613 with an end 611 that continuously connects to winding 614 with an end 612. Coil 650 includes a winding 653 with an end 651 that continuously connects to winding 654 with an end 652. The double-solid line of coil 650 is to distinguish coil 650 from coil 610 and does not mean that coil 650 is made from two parallel wires. Each of the coils 610 and 650 can have one or more characteristics of coil 210 described in relation to the preceding figures. The coil 610 can have an inductance L1 and the coil 650 can have an inductance L2. In some embodiments, L2 can be the same as L1 or be within 10% (e.g., within 5%, within 3%) of L1. The ends 611 and 651 can be electrically connected to each other, and/or the ends 612 and 652 can be electrically connected to each other, for example by soldering. When the coils 610 and 650 have a parallel connection, the effective inductance of the combined coils may be expressed as (1−k_{c}²)×L1×L2/(L1+L2−2×k_{c}×sqrt(L1×L2)), where k_{c} is the coupling between the coils 610 and 650 with a value between 0 and 1. Each of the side lengths 680 and 681 can be in a range from 400 mm to 500 mm (e.g., 450 mm to 550 mm, 500 mm to 600 mm, 550 mm to 650 mm, 600 mm to 700 mm).

The number of windings in coils 610 and 650 can vary. In the example shown in FIG. 6A, winding 613 of coil 610 includes outermost winding 620, second outermost winding 621 and innermost winding 622. Winding 653 of coil 650 includes outermost winding 660, second outermost winding 661 and innermost winding 662. The windings 620-622 of coil 610 are arranged alternately with windings 660-662 so that the outermost winding 660 is between outermost winding 620 and second outermost winding 621 of the coil 610. The second outermost winding 661 is between the second outermost winding 621 and innermost winding 622 of the coil 610.

Furthermore, winding 614 of coil 610 includes outermost winding 623, second outermost winding 624 and innermost winding 625. Winding 654 of coil 650 includes outermost winding 663, second outermost winding 664 and innermost winding 665. The windings 623-625 of coil 610 are arranged alternately with windings 663-665. However, opposite to the arrangement of windings 613 and 653, the order is reversed so that the outermost winding 623 is between outermost winding 663 and second outermost winding 624 of the coil 650. The second outermost winding 624 is between the second outermost winding 664 and innermost winding 665 of the coil 650. The alternating arrangements and the reversed ordering of the left and right side of windings in FIG. 6A provide a uniform magnetic field distribution. This configuration can provide advantages in that impedances of coils 610 and 650 can be balanced (e.g., same) so that currents are equally split into the coils 610 and 650. Moreover, the windings in to the two coils 610 and 650 can be arranged in a single common plane.

FIG. 6B is an image 685 of an example of a power transmitting apparatus 102 implementing the characteristics described in relation to FIG. 6A. In this example, the side length 681 of the coils is about 500 mm. Windings (e.g., outermost winding 620) of a first coil and windings (e.g., outermost winding 660) of a second coil are shown in the figure. Wires in box 686 are connected to each other and wires in box 687 are connected to each other to provide a parallel connection as described above.

While the features disclosed in relation to FIGS. 2-6B have been described for a power transmitting apparatus 102, it should be understood that a power receiving apparatus (e.g., power receiving apparatus 104 in FIG. 1) or power repeating apparatus can include similar elements and features. In addition, certain elements and/or features disclosed in connection with FIGS. 2-6B can be absent in a power receiving and/or power repeating apparatus. For example, a power receiving apparatus may not include a shield.

### Power Transmitting Apparatus Including Multiple Coils

Referring back to FIG. 3B, power transmitting apparatus 102 can generate a magnetic field distribution that extends in the C-direction on a side of coil 201 opposite to shield 230. A power receiving apparatus 104 can be positioned above the power transmitting apparatus 102 in the C-direction, and receive power through this magnetic field distribution. The magnetic field distribution can have field components parallel to the B-direction at location 332. Thus, when the power receiving apparatus 104 includes a coil arranged to efficiently generate currents by coupling to magnetic field components parallel in the B-direction, the apparatus 104 can efficiently receive power from the power transmitting apparatus 102.

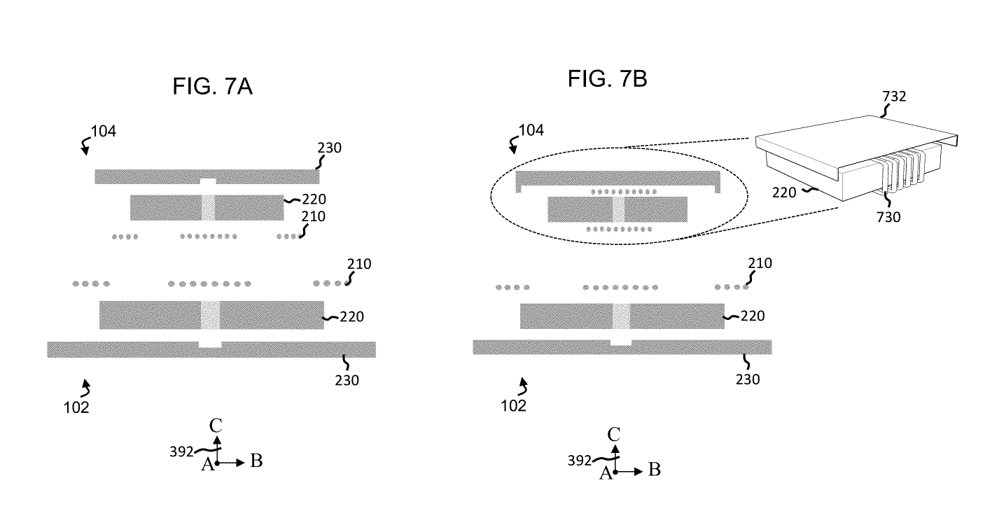

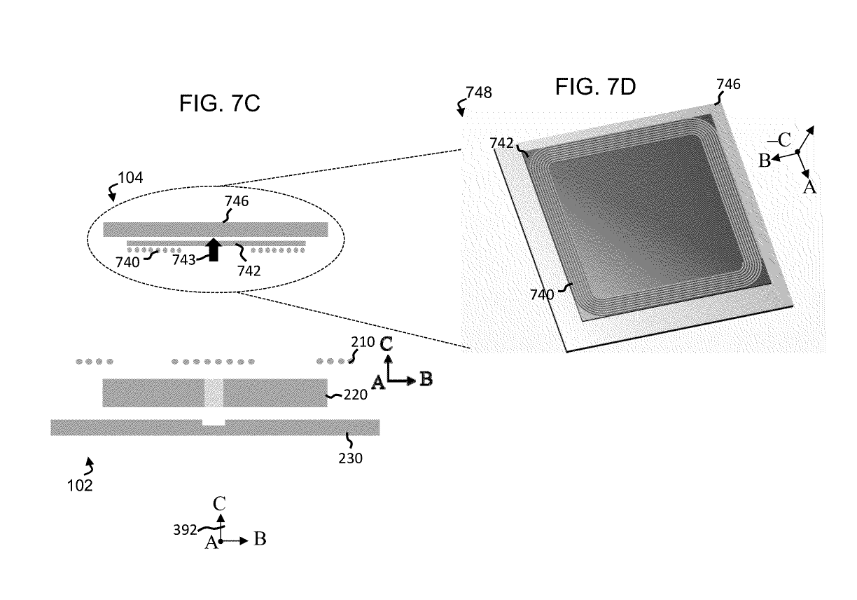

FIG. 7A is a schematic diagram of an example of a wireless power transfer system including a power receiving apparatus 104 that can efficiently receive power wirelessly from a power transmitting apparatus 102. Each of apparatuses 102 and 104 can have one or more characteristics described in relation to FIG. 3B, and the two apparatuses 102 and 104 can have different dimensions from each other. For example, coil 210 of apparatus 104 can have lengths 370 and 376 (as labeled in FIG. 3D) in the A-B plane that are smaller than lengths 370 and 376, respectively, of coil 210 of apparatus 102 because the power receiving apparatus 104 can be constrained by the size of a vehicle chassis on which it is installed.

The labeled elements of FIG. 7A have been described in detail with respect to the power transmitting apparatus 102, and thus will not be repeated. As discussed above, the power transmitting apparatus 102 can generate magnetic fields oriented parallel to the B-direction at a location above the power transmitting apparatus 102 in the C-direction, and such magnetic fields can efficiently excite current flow in coil 210 of the power receiving apparatus 104 to enable power transfer.

FIG. 7B is a schematic diagram of another embodiment of a wireless power transfer system. In this embodiment, power transmitting apparatus 102 is similar to power transmitting apparatus 102 in FIG. 7A. However, a vehicle can have an installed power receiving apparatus 104 that has a different arrangement from apparatus 104 shown in FIG. 7A. In FIG. 7B, the power receiving apparatus 104 includes a coil 730 that is wound around magnetic component 220. Shield 732 has flaps on its sides and is positioned above the coil 730 in the C-direction. Magnetic field components oriented parallel to the B-direction efficiently excite currents in the embodiment of power receiving apparatus 104 shown in FIG. 7B, so that the vehicle to which power receiving apparatus 704 is mounted can efficiently receive power from the power transmitting apparatus 102.

FIG. 7C is a schematic diagram of another embodiment of a wireless power transfer system. In this embodiment, power transmitting apparatus 102 is similar to power transmitting apparatus 102 in FIG. 7A. However, a vehicle can have an installed power receiving apparatus 104 that includes a coil 740 wound around a magnetic component 742, for example, as shown in perspective view 748 schematically depicted in FIG. 7D. Perspective view 748 (FIG. 7D) corresponds to a different viewing orientation (along the negative C-direction). Currents in such an arrangement of coil 740 can be effectively excited by magnetic fields oscillating parallel to the C-direction. This is indicated by magnetic dipole 743 in FIG. 7C. Hence, when the power transmitting apparatus 102 generates magnetic fields parallel to the B-direction, such fields do not efficiently excite currents in coil 740 of the power receiving apparatus 104, and hence, the vehicle cannot efficiently receive power from the power transmitting apparatus 102. Rather, a different power transmitting apparatus 102, for example, having an arrangement similar to power receiving apparatus 104 in FIG. 7C, can be utilized to generate magnetic fields parallel to the C-direction.

The examples described in FIGS. 7A-7C illustrate that a given power transmitting apparatus (e.g., apparatus 102 in FIG. 7A) may be better suited for use with some types of power receiving apparatuses (e.g., apparatuses 104 in FIGS. 7A and 7B) than with others (e.g., apparatus 104 in FIG. 7C). Various configurations for power transmitting apparatuses for use in generating magnetic fields and magnetic dipoles in various directions (i.e., for purposes of compatibility with different types of power receiving apparatuses) will now be discussed.

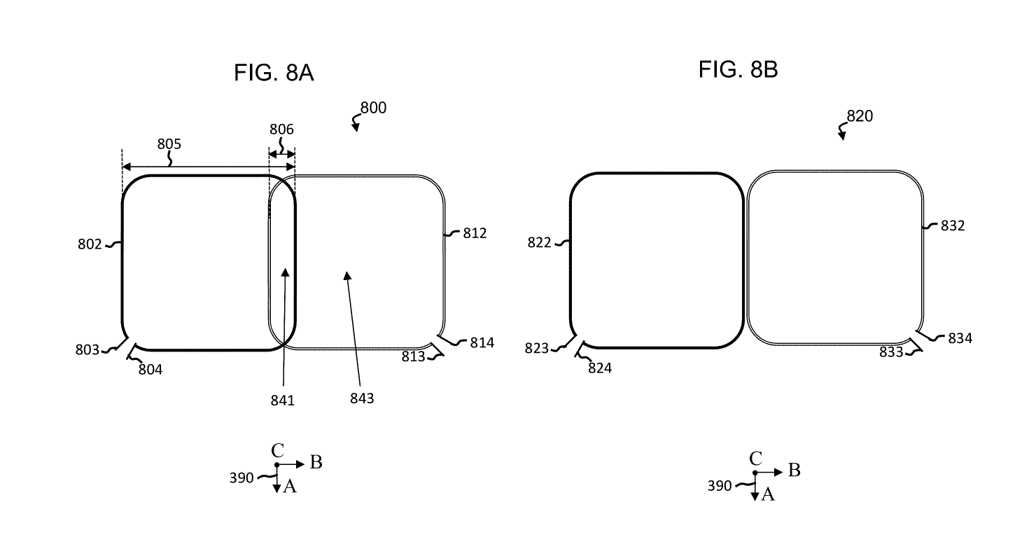

Generally, a power transmitting apparatus 102 can include multiple coils where magnitudes and phases of the currents driving each coil can be controlled independently of one another. FIG. 8A is a schematic diagram of a coil arrangement 800 that has two coils 802 and 812. Each coil can have at least one loop. The double-solid line of coil 812 is to distinguish coil 812 from coil 802 and does not mean that coil 812 is made from two parallel wires. Although, coils 802 and 812 are depicted as having one loop for simplicity, it is understood that each of coils 802 and 812 can include multiple loops, for example, as shown in connection with coil 720 of FIG. 7C. Coil 802 includes ends 803 and 804 from which currents flow into and out of the coil 802. Coil 812 includes ends 813 and 814 from which currents flow into and out of the coil 802. It is understood that the ends of each coil can be in any other location than that shown in the figures described herein.

In some embodiments, coil 802 can have a square shape with a side length 805. In certain embodiments, coil 812 can also have a square shape with the same, or different, side length. Generally, coils 802 and 812 can have other shapes than a square such as a circular or oval shape. In some embodiments, length 805 can be between 35 cm and 45 cm (e.g., between 30 cm and 40 cm, between 25 cm and 35 cm, between 20 cm and 30 cm.) The two coils 802 and 812 can be overlapped by an overlap length 806. In some embodiments, the length 806 can between 5-10% (e.g., between 10-15%, between 15-20%, between 20-25%, between 25-30%, between 30-35%) of length 805.

In the example shown in FIG. 8A, the combined area of area 841 and area 843 form the total enclosed area of coil 812. Area 841 corresponds to the overlapping area defined by the overlap of coil 802 and coil 812. The overlapping length 806 can reduce the coupling between coils 802 and 812. For example, the amount of current induced in coil 812 by oscillating current in coil 802 can be reduced. This is because magnetic fields produced by coil 802 in overlapping area 841 point in a direction opposite to magnetic fields produced by coil 802 in area 843. Because the magnetic field flux produced by coil 802 in areas 841 and 843 are in opposite directions, the net magnetic flux within the total enclosed area of coil 812 is less compared to the case where there is no overlap between coils 802 and 812. As mentioned above, the length 806 can be relatively smaller than length 805. The ratio of length 806 to length 805 can depend on the ratio of length 805 to length 802 and can be selected so that the net magnetic flux induced within the total enclosed area of one coil (e.g., coil 812) by the other coil (e.g., coil 802) can be substantially zero, for example, within 3% (e.g., within 5%, within 10%, within 20%) of the total magnetic flux of the total area enclosed by the other coil (e.g., coil 812). In other words, by adjusting the relative sizes of area 841 and 843, the net magnetic flux induced within coil 812 due to currents in coil 802 can be made substantially zero. Reducing coupling between coils 802 and 812 can provide easier control and impedance matching of the coils included in either a power transmitting apparatus 102 or a power receiving apparatus 104 to a power source 106 or a device 108, respectively.

Coil 802 can include a loop that lies in a first plane parallel to the A-B plane. In FIG. 8A, the first plane is the drawing plane. In this example, the loop has a first area defined by the shape of coil 802 with side length 805. Coil 812 can include a loop that lies in a second plane parallel to the A-B plane. In some embodiments, the second plane can be parallel to and slightly displaced (e.g., in the C-direction) from the drawing plane, for example, by an amount approximately equal to the thickness of the loop of coil 802. The loop of coil 812 has a second area (e.g., combination of areas 841 and 843) defined by shape of coil 812. When projected onto a common plane (e.g., A-B plane), the first area and the second area can have an overlapping region with a length 806 (e.g., measured in a direction parallel to the B-direction). The overlapping region can have an area of at least 5%, (e.g., at least 10%, at least, 15%, at least 20%, at least, 25%, at least 30%, at least 35%) of the first area (e.g., total area enclosed by coil 802).

In some embodiments, a decoupling transformer circuit (not shown) can have one terminal connected to ends 803 and 804, and another terminal connected to ends 813 and 814. The decoupling transformer circuit can generate a mutual inductance that cancels out the mutual inductance between coils 802 and 812 generated by the coupling mechanism described in the preceding paragraphs. In this case, the two coils 802 and 812 may not need an overlapping area as the mutual inductance can be controlled by the decoupling transformer.

FIG. 8B is a schematic diagram showing a coil arrangement 820 including two coils 822 and 832 with respective ends 823, 824, 833 and 834. In contrast to FIG. 8A, coils 822 and 832 do not have overlapping areas and the coupling between these coils can be larger than for coils 802 and 812 in FIG. 8A.

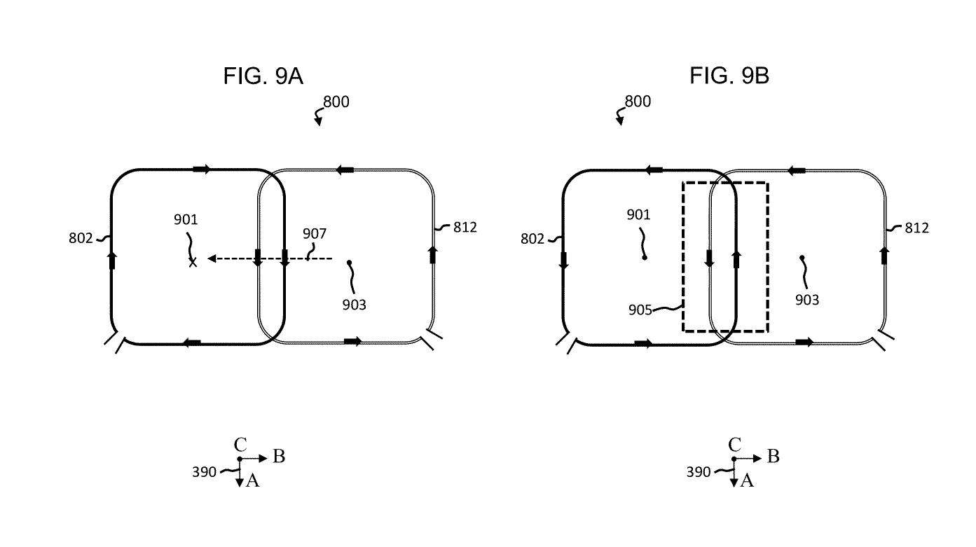

FIGS. 9A-9B are schematic diagrams of examples of controlling the generated magnetic field and magnetic dipoles using the coil arrangement 800 shown in FIG. 8A. In FIG. 9A, the coils 802 and 812 are driven so that their currents are circulating in opposite directions. For example, at a given time, coil 802 has currents flowing in a clock-wise direction and coil 812 has current flowing in the counter clock-wise direction as seen towards the drawing plane (i.e., towards the negative C-direction) as shown. Here, the coil 802 generates a magnetic dipole 901 pointing in the negative C-direction, and the coil 812 generates a magnetic dipole 903 pointing in the positive C-direction. As a result, at a location above the coil arrangement 800 in the positive C-direction, the magnetic field distribution has a field component parallel to the negative B-direction. It can also be said that the two coils 802 and 812 with opposite current flow generate a magnetic dipole 907 along the B-direction at a location above the two coils in the C-direction. The configuration of FIG. 9A can be used to generate magnetic field distributions provided by power transmitting apparatus 102 described in relation to FIGS. 7A and 7B.

In FIG. 9B, the coils 802 and 812 are driven so that their currents are circulating in same (or common) directions. For example, at a given time, both coils 802 and 812 have currents flowing in a counter clock-wise direction as viewed in the drawing plane. Here, both coils 802 and 812 generate magnetic dipoles 901 and 902 pointing in the positive C-direction. The currents in overlapping region 905 are flowing in opposite directions, and the effects of the currents can be considered to cancel out each other. Thus, in effect, the currents circulate an area of the combined coils 802 and 812 in the counter clock-wise direction. It can also be said that the two coils with the same current flow direction generate an effective magnetic dipole along the C-direction. Such a configuration of driving two coils can be used to generate a magnetic field distribution and magnetic dipole pointing in the C-direction so as to efficiently transfer power to power receiving apparatus 104 described in relation to FIG. 7C.

Accordingly, the same coil arrangement 800 can be used to generate magnetic fields and magnetic dipoles pointing either the B-direction or C-direction depending on the relative current direction in the two coils. Thus, a single arrangement can be used to efficiently transfer power to different types of power receiving apparatuses (e.g., apparatuses 104 in FIGS. 7A-7C). The current in the two coils can be independently controlled by a controller 103. In some embodiments, the controller 103 can drive currents in the two coils in the same direction. For example, at a given time, the same direction can be clock-wise. At a later time corresponding to a 180° phase change of the driving current, the same direction can be counter clock-wise. In some embodiments, the controller 103 can drive currents in the two coils in opposite directions. The controller 103 can control whether to drive the two coils in the same or opposite direction based on a feedback signal provide by a sensor. In some embodiments, the sensor can be included in a power transmitting apparatus and detect a type of power receiving apparatus in proximity to (e.g., within 40 cm or less, within 30 cm or less, within 20 cm or less) the power transmitting apparatus. When the power receiving apparatus can efficiently receive power through magnetic fields pointing in the B-direction, the controller 103 can drive the currents in coils 802 and 812 in the opposite direction. When the power receiving apparatus can efficiently receive power through magnetic fields pointing in the C-direction, the controller 103 can drive the currents in coils 802 and 812 in the same direction.

In some embodiments, the controller 103 can adjust the relative magnitude and phases of the two currents driving coils 802 and 812, respectively. The adjustment may be used to control the coupling between the two coils 802 and 812 to allow easier impedance matching conditions. In certain embodiments, a power transmitting apparatus 102 and a power receiving apparatus 104 can have a configuration (e.g., misaligned configuration) where a non-zero and non-180° relative phase of currents in coils 802 and 812 can provide a maximum power transfer efficiency. The controller 103 can tune the relative phase to find the value that leads to the maximum power transfer efficiency.

In some embodiments, the controller 103 can include separate current sources that drive currents in the coils 802 and 812, respectively. In some embodiments, the controller 103 can include a single common current source that drives currents in coils 802 and 812. The controller 103 can include phase delaying circuits to independently adjust the phase of currents in coils 802 and 812.

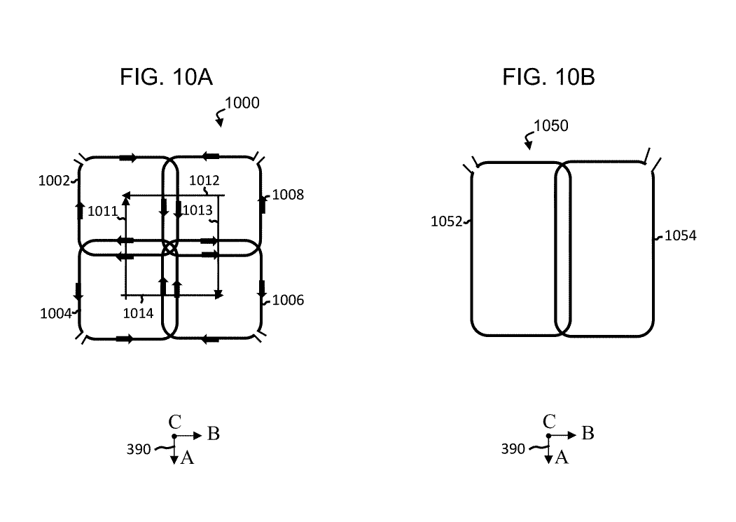

FIGS. 10A and 10B are schematic diagrams of other examples of coil arrangements. FIG. 10A is a schematic diagram of coil arrangement 1000 including four coils 1002-1008 arranged in a 2 by 2 rectangular array. Coils 1002 and 1006, which are diagonally positioned with respect to one another, have currents flowing in the same direction. Coils 1004 and 1008, which are diagonally positioned with respect to one another, also have currents flowing in the same direction, and in a direction opposite to the currents flowing in coils 1002 and 1006. For example, at a given time, currents in coils 1002 and 1006 circulate in a clockwise direction, while currents in coils 1004 and 1008 circulate in a counter-clockwise direction as shown in FIG. 10A. This pattern of current flow in coils 1002-1008 generates magnetic dipoles 1011-1014 above the coil arrangement 1000 in the C-direction. Far field radiation of opposing dipoles 1011 and 1013 can destructively interfere, and far field radiation of opposing dipoles 1012 and 1014 can destructively interfere. Therefore, in this approach, the coil arrangement 1000 can have reduced far field radiation, for example, in certain directions compared to an arrangement utilizing only one coil.

FIG. 10B is a schematic diagram of a coil arrangement 1050 including two coils 1052 and 1054. Each coil has a rectangular but non-square shape with a larger dimension extending in the A-direction. When currents in the coils 1052 and 1054 are driven in the manner described in connection with the embodiment of FIG. 9A, the coil arrangement 1050 can generate a comparatively larger area in the B-direction over which magnetic dipoles extend. Such an arrangement can be used when a power receiving apparatus receives power efficiently through magnetic dipoles pointing in the B-direction.

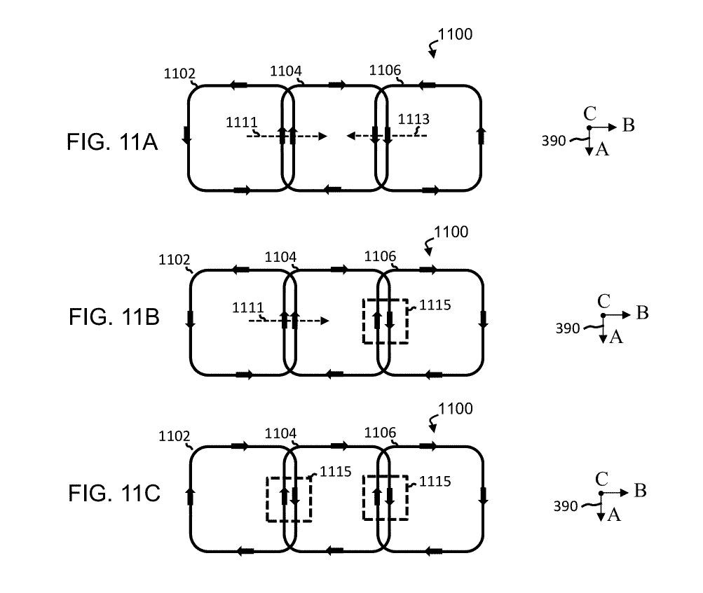

FIGS. 11A-11C are schematic diagrams showing a coil arrangement 1100 that includes three coils 1102-1106 in a power transmitting apparatus. Driving currents are applied differently to the three coils in each of the figures. For simplicity, the coils are depicted as closed loops and their ends are omitted in the figures. In FIG. 11A, currents in coils 1102 and 1106 are driven in the same (counter-clockwise) direction while current in coil 1104 is driven in the opposite (clockwise) direction, at a given time. As discussed above in connection with FIG. 9A, the coils 1102-1106 can generate magnetic dipoles 1111 and 1113 along the B-direction at a location above the arrangement 1100 in the C-direction. This arrangement can reduce far-field radiation emissions for the coils 1102-1106. For example, one or more coils of a power receiving apparatus can be closer to coil 1102 than to coil 1106, and then the power transfer to the power receiving apparatus can be dominantly achieved through magnetic dipole 1111. The far-field radiation of the dipole 1113 can be used to reduce to cancel far-field radiation emission by the magnetic dipole 1111 through destructive interference. As a result, total far-field radiation by coil arrangement 1110 can be reduced.

In FIG. 11B, currents in coils 1104 and 1106 are driven in the same (clockwise) direction while current in coil 1101 is driven in the opposite (counter-clockwise) direction, at a given time. Thus, coils 1102 and 1104 can generate a magnetic dipole 1111 along the B-direction at a location above the arrangement 1100 in the C-direction. On the other hand, currents in overlapping region 1115 effectively cancel out, and coils 1104 and 1106 can generate a magnetic dipole pointing along the C-direction, as described above in connection with FIG. 9B.

In FIG. 11C, all three coils 1102-1106 have currents flowing in the same (clockwise) direction at a given time. Accordingly, arrangement 1100 can generate a magnetic dipole pointing along the C-direction over the area of the three coils 1102-1106. The currents in overlapping regions 1115 effectively cancel out.

The power transfer systems disclosed herein can select and adjust various configurations of driving coils 1102-1106 using a controller 103. The selection and adjustment can be based on the type of the particular power receiving apparatus that receives power. For example, when the power receiving apparatus can efficiently receive power through magnetic dipoles oscillating in the A-B plane parallel to the plane of the coils, the controller 103 can drive the currents according to FIG. 11A. As another example, when the power receiving apparatus can efficiently receive power through magnetic dipoles oscillating in perpendicular to the plane of the coils, the controller 103 can drive the currents according to FIG. 11C. In some embodiments, power receiving apparatus can have two separate coils that each receive power efficiently from magnetic dipoles parallel and perpendicular to the A-B plane, respectively. In this case, the controller 103 can drive the current according to FIG. 11B.

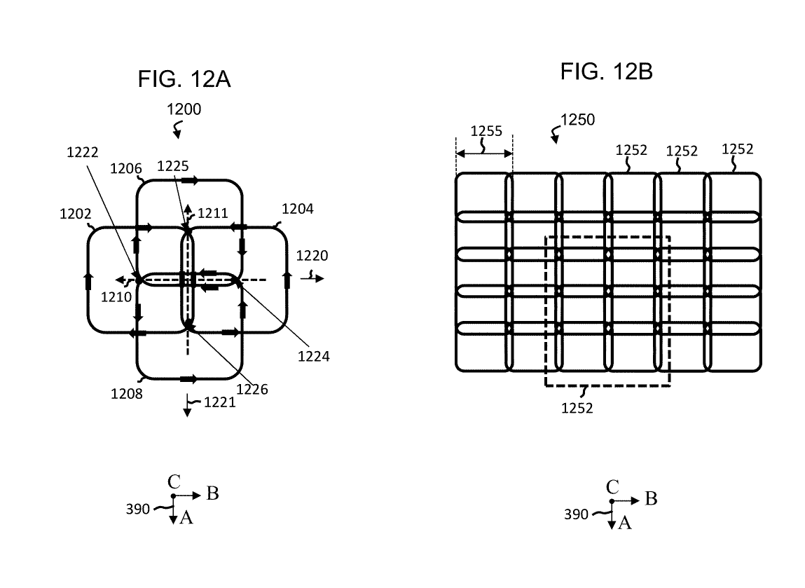

FIG. 12A is a schematic diagram of another embodiment of a coil arrangement 1200 including four coils 1202-1208. For simplicity, the coils are depicted as closed loops and their ends are omitted in the figure. Coils 1202 and 1204 are paired with an overlapping region, as described previously in connection with FIG. 9A. The coils 1202 and 1204 are arranged along a first direction 1220 parallel to the B-direction, which is defined by a line passing through center points 1222 and 1224 of the areas enclosed by coils 1202 and 1204. According to the mechanism described earlier, coils 1202 and 1204 can generate a magnetic dipole 1210 along the B-direction at a location above the arrangement 1200 in the C-direction.

Coils 1206 and 1208 are also paired with an overlapping region but rotated by 90° relative to the overlapping region of coils 1202 and 1204. Coils 1206 and 1208 can generate a magnetic dipole 1211 along the A-direction above the arrangement 1200 in the C-direction. The coils 1206 and 1208 are arranged along a second direction 1221 parallel to the A-direction, which is defined by a line passing through center points 1225 and 1226 of the areas enclosed by coils 1206 and 1208. Accordingly, the first direction 1220 is perpendicular to the second direction 1221. More generally, in some embodiments, the first direction 1220 and the second direction 1221 are not exactly orthogonal, but the included angle between the first and second directions is 75° or more (e.g., 80° or more, 85° or more, 87° or more). In some embodiments, the angle between the first and second directions is in a range from 75° to 105°.

In the embodiment shown in FIG. 12A, the magnetic dipoles 1210 and 1211 are orthogonal to each other. A controller 103 can selectively drive currents in the pair of coils 1202 and 1204 or the pair of coils 1206 and 1208 depending on the coil orientation of a power receiving apparatus. For example, when the power receiving apparatus can efficiently receive power through magnetic dipole 1211, the controller 103 can drive currents through the pair of coils 1206 and 1208.

In some embodiments, the controller 103 can drive currents through the pair of coils 1202 and 1204 and the pair of coils 1206 and 1208 at the same time. In this case, the effective magnetic dipole is the sum of dipoles 1201 and 1211. By controlling the relative magnitude of the driving currents and the relative magnitude of dipoles 1201 and 1211, the direction of the magnetic dipole can be controlled in any direction in the A-B plane. Accordingly, when the power receiving apparatus of a vehicle is offset (e.g., by rotation) from its ideal position, the controller 103 can adjust the direction of the effective magnetic dipole to align with the direction in which the power receiving apparatus can efficiently receive power.

In some embodiments, the controller 103 can drive currents through the pair of coils 1202 and 1204 with a phase difference of 90° relative to the currents that are driven through the pair of coils 1206 and 1208. By driving the pairs of coils out of phase, controller 103 can cause the effective magnetic dipole (which is the sum of magnetic dipoles 1210 and 1211) to rotate in the A-B plane. The generation of a rotating magnetic dipole can be used, for example, in a calibration process, to find the direction along which to align the effective magnetic dipole for efficient power transfer to the power receiving apparatus. In general, the phase difference between the driving currents applied to the pairs of coils may not be exactly 90° and can be between 80° and 100°.

In some embodiments, the controller 103 can drive currents through coils 1206 and 1208 to flow in the same direction, as discussed previously in connection with FIG. 9B. By driving currents in this manner, the magnetic dipole 1211 can point along the C-direction while magnetic dipole 1210 points along the B-direction. Accordingly, the effective magnetic dipole (i.e., the sum of magnetic dipoles 1210 and 1211) can point at any angle in the B-C plane. The controller 103 can adjust the magnitudes of the driving currents and dipoles 1210 and 1211 to control the angle in the B-C plane. Similarly, in some embodiments, the controller 103 can drive currents through coils 1202 and 1204 to generate the magnetic dipole 1210 to point along the C-direction, while magnetic dipole 1211 points along the A-direction. In this case, the controller 103 can control the direction of the effective magnetic dipole to point in any angle in the A-C plane.

Generally, a sensor of a power transmitting apparatus can detect an alignment between the power transmitting apparatus and power receiving apparatus. The sensor can send a feedback signal to controller 103 which can adjust the relative magnitude and phases of current flowing through coils 1202-1208 to control the direction of the generated effective magnetic dipole based on the feedback signal. For example, the relative magnitudes and phases between coil 1202 and coil 1206 can be adjusted. The direction of the effective magnetic dipole can be set in a direction in which the power receiving apparatus can efficiently receive power. Thus, the power transferred to the power receiving apparatus can be increased. Such an approach can also be implemented for the example shown in FIG. 10A.

FIG. 12B is a schematic diagram of another embodiment of a coil arrangement 1250 that includes an array of coils 1252. For simplicity, the coils are depicted as closed loops and their ends are omitted in the figure. In FIG. 12B, the array is a 6 coil by 5 coil array. More generally, however, the array can be an M by N array, where M≧3 and N≧3. Each coil 1252 can have one or more features that are similar to the features of coils in FIG. 8A. In some embodiments, the length 1255 can be smaller than that described that in FIG. 8A. For example, length 1255 can be 20 cm or less (e.g., 15 cm or less, 10 cm or less, 5 cm or less, 3 cm or less).

The relatively small sizes of the coils that are grouped together in FIG. 12B to form a large coil area can provide flexibility and control of the area of a power transmitting apparatus 102 used for generating magnetic fields. For example, when a vehicle to be charged is a truck, a vertical distance between the power transmitting apparatus 102 and a power receiving apparatus installed on the truck can be relatively large, compared to the vertical distance when the vehicle is a small car. When the distance is larger, coils with larger size and area can be utilized to generate magnetic near-fields with a longer decay length in different directions. On the other hand, when the distance is smaller (as may be in the case of the small car), coils with a smaller size and area can be used.

Magnetic fields extending long distances in the A- and B-direction(s) may penetrate the chassis of the vehicle and induce loss. Accordingly, controller 103 can be used to selectively drive all or only a subset of the array to select the area over which magnetic fields used for power transfer are distributed by the coils used in the power receiving apparatus. As an example, box 1252 indicates a region enclosing coils that are driven by currents to generate magnetic fields used for power transfer. When a larger region is needed, the controller 103 can increase the number of coils used for power transfer. In some embodiments, coils that are unused for power transfer can be have a resonant frequency detuned from the operating frequency of the driving currents.

Generally, controller 103 can select and drive currents through a subset of coils (e.g., coils in box 1252) among the M by N array. In some embodiments, the selection can be achieved by sending currents only through the selected coils in the subset. In some embodiments, the selection can be achieved by adjusting a variable capacitor (not shown) of each unselected coil (e.g., coils out of box 1252) to detune its resonant frequency away from the operating frequency of the driving currents. The resonant frequency of each unselected coil can be tuned away from frequency of electrical currents in the selected coils. Because they are detuned, the unselected coils do not efficiently transfer power to coils in the proximate power receiving apparatus.

In some embodiments, a sensor included in the power transmitting apparatus can detect a size of the power receiving apparatus. The sensor can send a feedback signal including the size information to controller 103. The controller 103 can adjust the number of coils in a selected subset of coils to control the effective area of coils that are used to transfer power to the power receiving apparatus. For example, when the size of coils within the power receiving apparatus is small, the controller 103 can select a small number of coils in the subset. Such an approach can reduce the number of unnecessary coils used in the power transfer and save power consumption of the power transfer system.

The methods for selectively driving coils in an array described in relation to FIG. 12B can have other advantages. For example, one or more coils can be damaged or have lossy objects placed on top of the coils. The controller 103 can selectively not drive currents through such coils or detune the resonant frequency of such coils to reduce loss during the power transfer.

Similar to the description of first and second coils in FIG. 9A, embodiments including more than two coils can include pairs (or larger numbers) of coils that overlap. For example, the examples described in relation to FIGS. 10A and 12A include a third coil and a fourth coil with an overlapping region having one or more characteristics described in relation to FIG. 9A. In some embodiments, different coils can have different sizes.

The techniques and coil arrangements described in relation to FIGS. 8A-12B can also be implemented for coils in power receiving apparatuses. As mentioned earlier, a magnetic component can be used to increase a magnetic flux density generated by the coils implemented in power transmission and receiving apparatuses. For example, a magnetic component having one or more characteristics described in connection with magnetic component 220 in FIGS. 2-5C can be placed below a plane of the coil arrangements described in FIGS. 9A-12B.

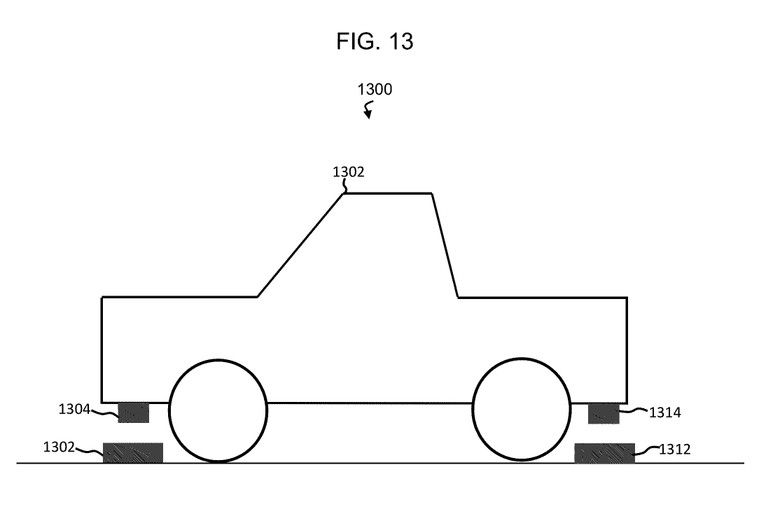

FIG. 13 is a schematic diagram of an example of a wireless power transfer system 1300 for charging a vehicle 1302. The vehicle 1302 can have two installed power receiving apparatuses 1304 and 1314, which are separated from each other. For example, the power receiving apparatus 1304 can be installed in the front chassis of the vehicle 1302, and the power receiving apparatus 1314 can be installed in the back chassis of the vehicle 1302. In some embodiments, either of the power receiving apparatuses can be installed in other parts (e.g., middle) of the chassis of the vehicle 1302. The system 1300 can include two power transmitting apparatuses 1302 and 1312, which are separated and positioned at complementary locations below respective power receiving apparatuses as shown in FIG. 13. The two power transmitting apparatuses 1302 and 1312 can positioned relative to each other while their mutual coupling is less that 15% (e.g., less than 10%, less than 5%) of the coupling between power receiving apparatuses 1304 and 1314 and the power transmitting apparatuses 1302 and 1312, respectively.

In some embodiments, one or both of the power transmitting apparatuses 1302 and 1312 can include one coil or multiple coils used for power transfer as described in the preceding paragraphs. The power transmitting apparatus 1302 can be separated from the power transmitting apparatus 1312 by 30 cm or more (e.g., 45 cm more, 60 cm or more, 90 cm or more, 1.5 m or more). Thus, one or more coils in the power transmitting apparatus 1302 can be separated from one or more coils in the power transmitting apparatus 1312, and coupling between the coils in these two apparatuses can be significantly less, for example, compared to the embodiment of FIG. 8B. Moreover, a controller 103 can control the relative phase of the driving currents between power transmitting apparatuses 1302 and 1312. By setting the relative phase to be about 180° (e.g., between 170° and 190°) the far field radiation from the one or more coils of apparatus 1302 can destructively interfere with the far field radiation from the one or more coils from apparatus 1312. Thus, the amount of far field radiation can be reduced through the destructive interference.

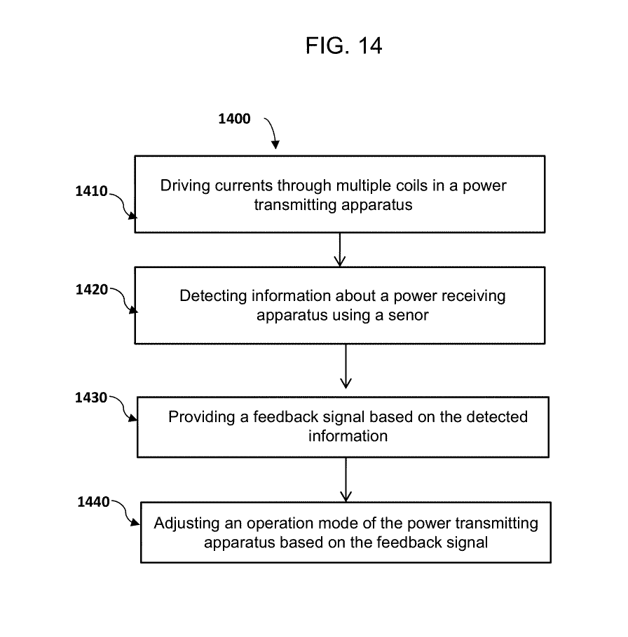

FIG. 14 is a flow chart 1400 that includes a series of example steps for wirelessly transferring power using a power transmitting apparatus 102 including multiple coils, as disclosed herein. At step 1410, currents are driven through multiple coils in the power transmitting apparatus 102. In some embodiments, multiple coils can include two coils 802 and 812 described in FIG. 9A. In some embodiments, multiple coils can include three coils 1102-1106 described in FIGS. 11A-11C, four coils 1002-1008 described FIG. 10A, or coils 1202-1208 described in FIG. 12A. In some other embodiments, multiple coils can include a M by N array of coils as described in FIG. 12B. A controller 103 can drive currents in pairs of coils in the same or opposite directions, as discussed above in connection with FIGS. 8A and 8B. The controller 103 can adjust the relative magnitudes and phases of currents driving the multiple coils. Moreover, the controller 103 can adjust the relative magnitudes and phases between two different groups of multiple coils, as discussed in connection with FIGS. 10A and 12B.

At step 1420, a sensor (e.g., included in a power transmitting apparatus) can be used to detect information about a power receiving apparatus in proximity to the power transmitting apparatus. For example, the information can include the type and/or size of the power receiving apparatus. In some embodiments, the power receiving apparatus can include a wireless communication interface (e.g., WiFi, Bluetooth, RF communication interface) that can wirelessly transmit information (e.g., type, size) about the power receiving apparatus to the sensor. In certain embodiments, the sensor can detect an alignment between coils of the power transmitting apparatus and coils of the power receiving apparatus. For example, the sensor can be a two-dimensional camera or laser detector that detects markings in the power receiving apparatus that are used to determine the relative alignment between the coils of the power transmitting and receiving apparatuses.

At step 1430, the sensor can provide a feedback signal based on the detected information at step 1420 to a controller 103.

At step 1440, the controller 103 can adjust an operation mode of the power transmitting apparatus based on the feedback signal. For example, depending on the detected type of coil arrangement in the power receiving apparatus, the controller 103 can change the current driving mode of the power transmitting apparatus between the current directions described in connection with FIGS. 9A and 9B. In some embodiments, the controller 103 can change a relative magnitude and/or phase between pairs of coils to adjust the orientation of the generated effective magnetic dipole, for example, in the manner described in connection with FIG. 12A.

In certain embodiments, the feedback signal can be based on information about a coil size of the power receiving apparatus and/or separation distance between the coils of the power transmitting apparatus and the power receiving apparatus. The controller 103 can calculate the overall areal size of a subset of coils in the power transmitting apparatus to be used for power transfer based on the feedback signal. The controller 103 can select and adjust the number of coils included in a subset of coils of the power transmitting apparatus to change the overall size of the subset of coils.

### Operation Frequency

The disclosed techniques can be implemented for relatively low operating frequencies where a shield can have higher loss properties than at high operating frequencies. The operating frequency of a wireless power transfer system can be chosen as the frequency of minimum loss of the combined contribution of losses of an apparatus including elements such as a shield, coil, magnetic component and electronics such as amplifiers and DC-AC converters of the system. For example, the shield can have lower losses as the operating frequency increases, and the coil can have lower losses as long as the frequency is low enough that radiative losses in the coils are lower than ohmic losses in the coil. On the other hand, the electronics can have higher losses as the operating frequency increases. An optimum frequency can exist where the combined losses are minimized. In addition, the operating frequency of a wireless power transfer system may be chosen to exist within certain pre-specified frequency bands determined by a regulatory agency, a standards committee, or a government or military organization. In some cases, the coil and shield designs are optimized to operate at a specified frequency and/or within a certain frequency range.

For example, such an operating frequency can be about 85 kHz. As the shield can have higher losses at 85 kHz than at higher frequencies, the shield can include one or more openings to reduce losses that would otherwise be induced within the shield due to magnetic field coupling. In some embodiments, the operating frequency can be at about 145 kHz. In high power applications, the losses of the electronics are typically lower for operating frequencies below 200 kHz, and thus certain high power applications are designed to operate at 20 kHz, 50 kHz, 85 kHz, and 145 kHz. In low power applications (e.g., low power consumer electronics), certain applications are designed to operate at the Industrial, Scientific and Medical (ISM) frequencies, where conducted and radiated emissions are not subject to regulatory restrictions. The ISM frequencies include 6.78 MHz, 13.56 MHz and many harmonics of 13.56 MHz.

### Hardware and Software Implementation

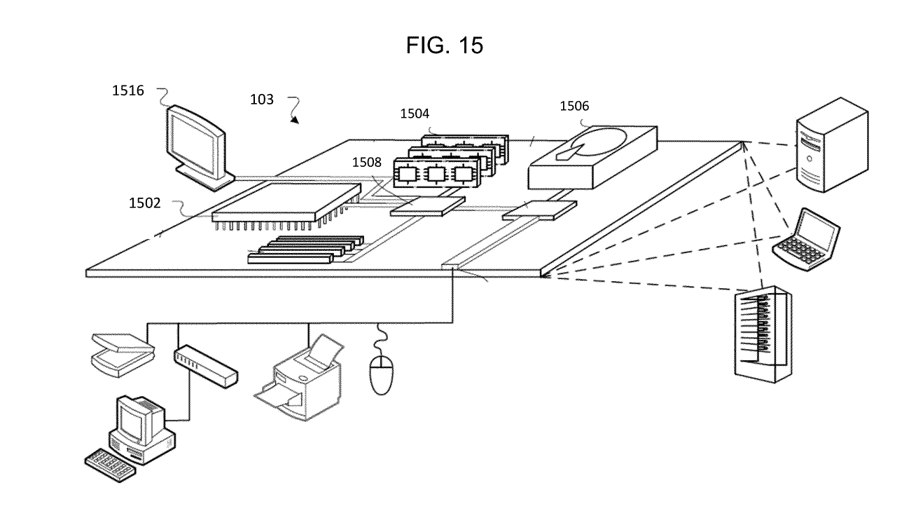

FIG. 15 shows an example of an electronic controller 103, which may be used with the apparatus and methods described herein. As mentioned earlier, the electronic controller 103 can be used to control power transfer of a wireless power transfer system, for example, by changing power output of a power source, adjusting operation and/or resonant frequencies and adjusting impedance matching networks. The electronic controller 103 can be used to control the current directions, magnitudes and phases of different coils relative to other coils. In some embodiments, the electronic controller 103 can be directly connected to, or wirelessly communicate with, various elements of the system.

Electronic controller 103 can include a processor 1502, memory 1504, a storage device 1506 and interfaces 1508 for interconnection. The processor 1502 can process instructions for execution within the electronic controller 103, including instructions stored in the memory 1504 or on the storage device 1506. For example, the instructions can instruct the processor 1502 to determine parameters of the system such as efficiency of power transfer, operating frequency, resonant frequencies of resonators and impedance matching conditions. The electronic controller 103 can determine type, size and alignment of a power receiving apparatus based on detection signals from one or more sensors. In certain embodiments, the processor 1502 is configured to send out control signals to various elements (e.g., power source, power transmitting apparatus, power receiving apparatus, power repeating apparatus, impedance matching networks) to adjust the determined parameters. For example, control signals can be used to tune capacitance values of capacitors in an impedance matching network. In certain embodiments, control signals can be used to adjust operation frequency of a power source. Control signals can change capacitance value of a capacitor in a resonator to tune its resonant frequency.

The memory 1504 can store information about optimized parameters of the system. For example, the information can include optimized impedance matching conditions for various levels of power output from the power source. In certain embodiments, the memory 1504 can store information such as resonant frequencies of resonator and magnetic properties (e.g., magnetic permeability depending on power levels) of magnetic components in the system, which can be used by the processor 1502 for determining signals to be sent out to control various elements in the system.

The storage device 1506 can be a computer-readable medium, such as a floppy disk device, a hard disk device, an optical disk device, or a tape device, a flash memory or other similar solid state memory device, or an array of devices, including devices in a storage area network or other configurations. The storage device 1506 can store instructions that can be executed by processor 1502 described above. In certain embodiments, the storage device 1506 can store information described in relation to memory 1504.

In some embodiments, electronic controller 103 can include a graphics processing unit to display graphical information (e.g., using a GUI or text interface) on an external input/output device, such as display 1516. The graphical information can be displayed by a display device (e.g., a CRT (cathode ray tube) or LCD (liquid crystal display) monitor) for displaying information. A user can use input devices (e.g., keyboard, pointing device, touch screen, speech recognition device) to provide input to the electronic controller 103. In some embodiments, the user can monitor the display 1516 to analyze the power transfer conditions of the system. For example, when the power transfer is not in optimum condition, the user can adjust parameters (e.g., power transfer level, capacitor values in impedance matching networks, operation frequency of power source, resonant frequencies of resonators) by inputting information through the input devices. Based on the receive input, the electronic controller 103 can control the system as described above.

In some embodiments, the electronic controller 103 can monitor hazardous conditions of the system. For example, the electronic controller 103 can detect over-heating in the system and provide an alert (e.g., visual and/or audible alert) to the user through its graphical display or audio device.

In certain embodiments, electronic controller 103 can be used to control magnitudes and phases of currents flowing in one or more coils of the wireless power transfer system. For example, processor 1502 can calculate and determine the magnitudes and phase of currents to be supplied to coils in a power transmitting apparatus. The determination can be based on the monitored power transfer efficiency and information stored in memory 1504 or storage 1506.

A feedback signal can be received and processed by the electronic controller 103. For example, the electronic controller 103 can include a wireless communication device (e.g., radio-frequency, Bluetooth receiver) to receive information from either or both of a power transmitting apparatus and a power receiving apparatus (which can have its own wireless communication device). In some embodiments, the received information can be processed by processor 1502, which can further send out control signals to adjust parameters of the system as described above. For example, the control signals can be used to adjust the magnitudes and phases of currents flowing in one or more coils of resonators in the system to increase the power transfer efficiency.

Various embodiments of the systems and techniques described here can be realized by one or more computer programs that are executable and/or interpretable on the electronic controller 103. These computer programs (also known as programs, software, software applications or code) include machine instructions for a programmable processor, and can be implemented in a high-level procedural and/or object-oriented programming language, and/or in assembly/machine language. For example, computer programs can contain the instructions that can be stored in memory 1504 and storage 1506 and executed by processor 1502 as described above. As used herein, the terms “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

Generally, electronic controller 103 can be implemented in a computing system to implement the operations described above. For example, the computing system can include a back end component (e.g., as a data server), or a middleware component (e.g., an application server), or a front end component (e.g., a client computer having a graphical user-interface), or any combination therefor, to allow a user to utilized the operations of the electronic controller 103.

The electronic controller 103 or one or more of its elements can be integrated in a vehicle. The electronic controller 103 can be utilized to control and/or monitor wireless power charging of a battery installed in the vehicle. In some embodiments, the display 1516 can be installed adjacent to the driving wheel of the vehicle so that a user may monitor conditions of the power charging and/or control parameters of the power charging as described in relation to FIG. 15. The display 1516 can also visualize information traffic information and road maps based on Global Positioning System (GPS) information. Any of the elements such as the processor 1502, memory 1504 and storage device 1506 can be installed in the space behind the display 1516, which can visualize the data process by those elements.

### Other Embodiments

While this disclosure contains many specific implementation details, these should not be construed as limitations on the scope of the disclosure, but rather as descriptions of features specific to particular embodiments. Features that are described in the context of separate embodiments can also generally be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can generally be excised from the combination, and the claimed combination may be directed to a subcombination or variation of a subcombination.

In addition to the embodiments expressly disclosed herein, other embodiments are within the scope of the disclosure.

What is claimed is:

1. A transmitter for wireless power transfer, comprising:
a first coil comprising at least one loop extending in a first plane, wherein the first coil encloses a first area in the first plane;
a second coil comprising at least one loop extending in the first plane, wherein the second coil encloses a second area in the first plane adjacent to the first area; and
a controller configured to drive the first and second coils with electrical currents during operation of the transmitter,
wherein the controller is configured so that during operation of the transmitter:
in a first mode of operation, the controller drives the first and second coils to generate a magnetic field having a dipole moment that is parallel to the first plane to wirelessly transmit power to first and second receivers; and
in a second mode of operation, the controller drives at least one of the first and second coils to generate a magnetic field having a dipole moment that is orthogonal to the first plane to wirelessly transmit power to a third receiver.

2. The transmitter of claim 1, wherein the second area overlaps at least 10% of the first area in the first plane.

3. The transmitter of claim 1, wherein in the first mode of operation, the controller is configured to drive the first coil with an electrical current in a first circulating direction in the first plane, and to drive the second coil with an electrical current in a second circulating direction in the first plane opposite to the first circulating direction.

4. The transmitter of claim 1, wherein in the second mode of operation, the controller is configured to drive the first coil with an electrical current in a first circulating direction in the first plane, and to drive the second coil with an electrical current in the first circulating direction in the first plane.

5. The transmitter of claim 1, further comprising:
a sensor configured to determine information about which of the first, second, and third receivers is positioned in proximity to the transmitter and to transmit a signal to the controller comprising the information,
wherein the controller is configured to operate in either the first or second mode based on the information.

6. The transmitter of claim 1, wherein the transmitter comprises:
a third coil comprising at least one loop extending in the first plane, wherein the third coil encloses a third area in the first plane; and
a fourth coil comprising at least one loop extending in the first plane, wherein the fourth coil encloses a fourth area in the first plane.

7. The transmitter of claim 6, wherein the first, second, third, and fourth coils are arranged in a 2 by 2 rectangular array in the first plane.

8. The transmitter of claim 6, wherein:
the first coil and the second coil are spaced from one another along a first direction connecting centers of the first area and the second area in the first plane;
the third coil and the fourth coil are spaced from one another along a second direction connecting centers of the third area and the fourth area in the first plane; and
an angle between the first direction and the second direction is in a range from 75° to 105°.

9. The transmitter of claim 6, wherein during operation of the transmitter, the controller is configured to drive each of the first, second, third, and fourth coils with electrical currents.

10. The transmitter of claim 9, wherein during operation of the transmitter, the controller is configured to drive the first and second coils with electrical currents in a first circulating direction in the first plane, and to drive the third and fourth coils with electrical currents in a second circulating direction in the first plane opposite to the first circulating direction.

11. The transmitter of claim 10, wherein during operation of the transmitter, the controller is configured to drive the first and third coils with oscillating electrical currents having a phase difference of between 80° and 100°.

12. The transmitter of claim 9, wherein during operation of the transmitter, the controller is configured to drive the first coil with an electrical current in a first circulating direction in the first plane, to drive the second coil with an electrical current in a second circulating direction in the first plane opposite to the first circulating direction, and to drive the third and fourth coils with electrical currents in a common circulating direction in the first plane.

13. The transmitter of claim 12, wherein the common circulating direction corresponds to the first circulating direction.

14. The transmitter of claim 12, wherein the common circulating direction corresponds to the second circulating direction.

15. The transmitter of claim 9, further comprising a sensor configured to determine information about a proximity of each of the receivers to the transmitter, and to transmit a signal comprising the information to the controller.

16. The transmitter of claim 15, wherein during operation of the transmitter, the controller is configured to adjust magnitudes of electrical currents used to drive the first coil and the third coil based on the information.

17. The transmitter of claim 1, further comprising multiple additional coils each comprising at least one loop extending in the first plane, wherein the first, second, and multiple additional coils are positioned to form a M by N rectangular array of coils in the first plane, and wherein M≧3 and N≧3.

18. The transmitter of claim 17, wherein the controller is configured to selectively activate a subset of the M by N array of coils during operation of the transmitter to generate a magnetic field distribution to wirelessly transmit power to at least one of the first, second, and third receivers.

19. The transmitter of claim 18, wherein the controller is configured to selectively activate the subset of the M by N array of coils during operation of the transmitter by selectively circulating electrical currents only through coils in the array corresponding to the subset.

20. The transmitter of claim 18, wherein the controller is configured to selectively activate the subset of the M by N array of coils during operation of the transmitter by tuning resonant frequencies of coils in the M by N array that are not in the subset away from a frequency of oscillating electrical currents that are circulated by the controller through coils in the array corresponding to the subset.

21. The transmitter of claim 20, wherein the controller is configured to tune the resonant frequencies of the coils that are not in the subset during operation of the transmitter by adjusting variable capacitors connected to each of the coils.

22. The transmitter of claim 18, further comprising a sensor configured to detect a size of at least one of the first, second, and third receivers, and to transmit a signal comprising information about the size to the controller.

23. The transmitter of claim 22, wherein the controller is configured to adjust which members of the M by N array of coils form the subset based on the size information.
